(19) United States
(12) Patent Application Publication
(10) Pub. No.: US 2014/0014418 A1
(43) Pub. Date: Jan. 16, 2014

(54) POWER SUPPLY DEVICE, POWER-SUPPLY-DEVICE SEPARATOR, AND POWER-SUPPLY-DEVICE-EQUIPPED VEHICLE

(71) Applicants: Tsuyoshi KOMAKI, Kasai-shi (JP); Tomohisa Kuriyama, Sanda-shi (JP)

(72) Inventors: Tsuyoshi KOMAKI, Kasai-shi (JP); Tomohisa Kuriyama, Sanda-shi (JP)

(21) Appl. No.: 13/549,790

(22) Filed: Jul. 16, 2012

(51) Int. Cl. H01M 10/50; B60K 1/04; H01M 2/18

(52) U.S. Cl. 180/65.1; 429/72; 429/143

(57) ABSTRACT

A power supply includes batteries, separators, a base plate, and an elastic seal. The batteries have a rectangular-box exterior shape. The separators are interposed between the batteries. The batteries are arranged side by side. The base plate has one surface onto which a battery block of the batteries is fastened. The seal is interposed between a bottom surface of the battery block and an upper surface of the base plate, thereby airtightly closing gaps between them. The separator has recessed parts that form gas-flowing paths between the batteries so that cooling gas can flow along surfaces of the batteries when the separator is interposed between the batteries. The separator includes a plate-shaped bottom cover that is arranged on a bottom surface side of the separator, and protrudes in the side-by-side arrangement direction of the batteries. The bottom cover has a recessed part that is arranged on the seal.

### BACKGROUND OF THE INVENTION

1. Field of the Invention

The present invention mainly relates to a power supply device that can be used as a large current power supply for an electric motor for driving cars such as a hybrid car and an electric vehicle, and as electric power storages for home use and manufacturing plants, and a separator that can be used for this type of power supply device. The present invention also relates to a vehicle and an electric power storage including this power supply device.

2. Description of the Related Art

Power supply devices such as battery packs for vehicles are required which can supply high electric power. In order to accommodate a number of battery cells in limited space, the high power supply devices generally include rectangular batteries, which can efficiently occupy space. The rectangular battery includes electrode members, and a rectangular exterior case that accommodates the current collectors, and a sealing plate that seals the exterior case. A number of rectangular batteries are arranged side by side with electrically insulating members such as resin separators interposed between the rectangular battery cells. After the battery cells and the separators are alternately arranged, the battery cells and the separators are securely held by bind bars or the like to provide a battery block.

Japanese Patent Laid-Open Publication No. JP 2010-287,550 A discloses a battery block 210 that includes a plurality of rectangular battery cells 201, electrically-insulating separators 202 interposed between the rectangular battery cells 201 disposed adjacent to each other, end plates 204 arranged on the end surfaces of a battery assembly constructed of the rectangular battery cells 201 and the separators 202, and bind bars 205 that couple the end plates 204 on the end surfaces to each other, as shown in an exploded perspective view of FIG. 23 and a schematic cross-sectional view of FIG. 24. In addition, the separators 202 form cooling gas-flowing paths 206 between battery cells 201. Cooling air can flow through cooling gas-flowing paths 206 and cool the battery cells 201. In addition, the surfaces of each of the battery cells 201 are covered for electric insulation by a bag-shaped electrically insulating sheet 211 (e.g., PET resin etc.) as shown in an enlarged cross-sectional view of FIG. 24.

In this battery block 210, cooling air is supplied from a side surface side, and flows through cooling gas-flowing paths 206, which are defined by the separator 202 and formed between the battery cells 201, so that the battery cells 201 can be cooled. The battery block 210 is fastened onto a base plate 207 as shown in a cross-sectional view of FIG. 25.

However, if a gap 208 is formed between the battery block 210 and the base plate 207 as shown in the cross-sectional view of FIG. 25, cooling gas blown to a side surface of the battery block 210 will flow into this gap 208, which in turn disturbs sufficient air flow in the cooling gaps 206, which are defined by the separator 202. As a result, a problem will arise in that the cooling performance for cooling the battery block 210 decreases.

The base plate 207 can have protruding portions or recessed portions 209, which can be formed by drawing or the like, for increasing the stiffness as shown in FIG. 25. In particular, in the case where the base plate 207 has the protruding portions or recessed portions, the gap 208 is likely to be formed between the battery block 210 and the base plate 207. Accordingly, cooling gas is likely to flow into the gap 208. As a result, the cooling efficiency will decrease.

The rectangular battery cell 201 includes a rectangular exterior container 201a. As shown in FIG. 26, the rectangular exterior container 201a is covered by a bag-shaped heat contraction sheet 211A with the upper surface of the battery cell 201 being exposed. Specifically, a tube-shaped heat contraction sheet having upper and lower opened ends is divided by cutting into heat contraction sheets 211A, which have a certain length. As shown in FIG. 26, the battery cell 201 is inserted from the open end into the heat contraction sheet 211A. After that, as shown in FIGS. 27(a) and 27(b), the heat contraction sheet 211A is shrink-fitted over the battery cell 201. Thus, the heat contraction sheet 211A is brought in intimate contact with surfaces of the exterior container 201a. The opposed end parts of the heat contraction sheet 211A are welded on the bottom surface side of the battery cell 201 by heat. In addition, after a margin of heat contraction sheet 211A is cut off, surfaces of the battery cell 201 are covered by the heat contraction sheet 211A. In this case, it is difficult to completely remove the margin of heat contraction sheet 211A. Accordingly, a certain amount of margin is required to prevent the heat contraction sheet 211A from being damaged on the bottom surface of the battery cell 201 when the margin is cut off. The reason is to avoid the bottom surface of the exterior container 201a is partially exposed. As a result, as shown in a three-view drawing of FIG. 28, a welded part 211a of the heat contraction sheet 211A will protrude beyond a welding line HL on the bottom surface side of the battery cell 201.

For this reason, the protruding amounts of the welded parts 211a of the battery cells 201 that protrude from the bottom surfaces of the battery cells 201 cannot be constant. Accordingly, the difference between the welded parts 211a may cause vertical positional deviation of the bottom surfaces of the battery cells 201 when a plurality of battery cells 201 are arranged side by side. As a result, gaps may be formed between the bottom surfaces of the battery blocks and the base plate. In this case, when cooling gas is blown to a side surface of the battery block 210 for cooling the battery block 210, the cooling gas flows not only through the gaps between battery cells 201 but also through the gap under the bottom surface of the battery block 210. Accordingly, as discussed above, the flowing amount of cooling gas will decrease. Consequently, a problem will arise in that the cooling efficiency decreases.

The present invention is aimed at solving the problem. It is a main object of the present invention is to provide a power supply device, a separator to be used in a power supply device, a power-supply-device separator, and a power-supply-device-equipped vehicle and electric power storage that can efficiently cool battery cells.

### SUMMARY OF THE INVENTION

To achieve the above object, a power supply device according to a first aspect of the present invention includes a plurality of battery cells, a separator, a base plate, and an elastic sealing member. The plurality of battery cells has a rectangular-box exterior shape. The separator is interposed between the plurality of battery cells. The plurality of battery cells are arranged side by side. The base plate has one surface onto which the battery block of the plurality of battery cells is fastened. The sealing member is interposed between the bottom surface of the battery block and the upper surface of the base plate thereby airtightly closing gaps between the bottom surface of the battery block and the upper surface of the base plate. The separator has recessed parts that form a plurality of gas-flowing paths between the battery cells so that cooling gas can flow along surfaces of the battery cells when the separator is interposed between the battery cells. The separator includes a plate-shaped bottom surface cover portion that is arranged on the bottom surface side of the separator, and protrudes in the side-by-side arrangement direction of the battery cells. The bottom surface cover portion has a recessed part that is arranged on the sealing member.

According to this construction, since the gap between the battery block and the base plate is filled with the sealing member; it is possible to prevent cooling gas from flowing through this gap. In addition, since the separator has the recessed part that holds the sealing member, the sealing member can be arranged in place under the bottom surface of the battery block.

In a power supply device according to a second aspect of the present invention, the recessed part can have a groove shape that extends in the side-by-side arrangement direction of the battery cells so that the groove-shaped recessed part can open and extend from one edge to the other edge of the bottom surface cover portion.

According to this construction, since the recessed parts formed on the bottom surfaces of the separators have a groove shape that extends from one edge to the other edge of the bottom surface cover portion, the entire sealing member can be evenly absorbed in thickness. Therefore, the battery block can be evenly held in height.

In a power supply device according to a third aspect of the present invention, the groove-shaped recessed parts, which are formed on the bottom surface cover portions of the separators, can be aligned in a straight line on the bottom surface of the battery block so that the sealing member can be held in a straight groove portion, which is formed by the aligned groove-shaped parts.

According to this construction, since, after the separators are arranged side by side, the groove-shaped recessed parts are aliened in a straight line on the bottom surface of the battery block so that aligned groove-shaped parts (straight groove portion) are formed, the sealing member is held in the straight groove portion, the entire sealing member can be evenly held in thickness. Therefore, the battery block can be evenly held in height. In addition, since the straight groove portions of the separators adjacent to each other communicate with each other, the sealing member can be smoothly held in the boundary part of between adjacent separators. Therefore, it is also possible to airtightly seal the boundary part.

In a power supply device according to a fourth aspect of the present invention, the groove-shaped recessed part can be formed in the central part of the bottom surface cover portion.

According to this construction, in the case where the separators that have the same shape are arranged side by side with being flipped from side to side, since the groove-shaped recessed parts are arranged in the central part of the bottom surface of the battery block, the straight groove portion can extend in a straight line.

In a power supply device according to a fifth aspect of the present invention, the sealing member can have a band shape that can be held along the aligned groove-shaped parts.

According to this construction, since the band-shaped sealing member can continuously close the gap between the battery block and the base plate, it is possible to effectively prevent air leakage through this gap.

In a power supply device according to a sixth aspect of the present invention, the sealing member can be formed of urethane or EPDM.

According to this construction, since the sealing member can have excellent elasticity and airtight sealing performance, this sealing member can reliably close the gap between the battery block and the base plate.

In a power supply device according to a seventh aspect of the present invention, the surfaces of each of the battery cells can be covered by an electrically insulating heat contraction sheet. The heat contraction sheet covers and closes the battery cell with at least bottom parts of the heat contraction sheet being welded to each other under the bottom surface of the battery cell. The bottom surface cover portions can form a bottom surface opening between the separators adjacent to each other so that the welded part of the heat contraction sheet can be guided into the bottom surface opening. When the separators adjacent to each other are opposed to each other, the welded part of the heat contraction sheet can be arranged in the bottom surface opening.

According to this construction, since the welded part the heat contraction sheet that protrudes from the bottom surface of the battery cell is arranged in the bottom surface opening that is formed between the bottom surface cover portions of the separators adjacent to each other, it is possible to eliminate any adverse influence of the welded part, which protrudes from the bottom surface of the battery cell, when the battery cell is guided to a predetermined position between the separators.

In a power supply device according to an eighth aspect of the present invention, the bottom surface cover portion can have a thickness that is larger than the protruding amount of the welded part.

According to this construction, it is possible to prevent the welded part of the heat contraction sheet from protruding from the bottom surfaces of the separators, and being interposed between the bottom surface of the battery block, and the base plate. Therefore, the base plate can be arranged close to the battery block.

In a power supply device according to a ninth aspect of the present invention, the bottom surface opening can open along the center line that divides the bottom surface of the battery cell into halves in the shorter edge direction.

According to this construction, although the opening area of the bottom surface opening can be small, it can be ensured that the welded part of the heat contraction sheet is guided into the bottom surface opening.

In a power supply device according to a tenth aspect of the present invention, the bottom surface opening can open from one side edge to the other side edge of the battery cell.

According to this construction, the welded part of the heat contraction sheet can be guided to the bottom surface opening along the length of the bottom surface of the battery cell.

In a power supply device according to an eleventh aspect of the present invention, the opening width of the bottom surface opening can be wider on both side ends than at the center of the bottom surface opening.

According to this construction, even if the welding part becomes wider on the edge sides on the bottom surface of the battery cell, the wider edge sides of the welding part can be guided into the bottom surface opening that has a wider width on both side ends. Therefore, it is possible to avoid the welding part protruding from the bottom surface of the battery block.

In a power supply device according to a twelfth aspect of the present invention, the opposed edges of the bottom surface cover portions that are opposed to each other can have a curved, trapezoid or triangular convex shape that protrudes in the center of the bottom surface cover portion as viewed from the bottom surface side so that the opening width of the bottom surface opening can be wider on the side ends than at the center of the bottom surface opening.

According to this construction, the opening width of the bottom surface opening can be wide on both side ends, while the area of the bottom surface cover portion can be large. Therefore, the bottom surface of the battery cell can be securely held by the bottom surface cover portions. In addition, since the bottom surface cover portions have a convex shape that protrudes in the center of the bottom surface cover portion, the protruding amount of the central part of the bottom surface cover portion can be large. As a result, the opening width of the central part of the bottom surface opening formed between the opposed bottom surface cover portions can be small. Therefore, it is possible to reduce air leakage through the bottom surface opening.

In a power supply device according to a thirteenth aspect of the present invention, the recessed part can have a groove shape that extends in the side-by-side arrangement direction of the battery cells so that the groove-shaped recessed part can open and extend from one edge to the other edge in the central part of the bottom surface cover portion.

According to this construction, since the sealing member is arranged in the groove-shaped recessed part in the central part of surface cover portion, which reduces the opening width of the bottom surface opening, it is possible to efficiently close the gap between the battery block and the base plate.

In a power supply device according to a fourteenth aspect of the present invention, the base plate can have a protruding portion or recessed portion that is formed in at least a part onto which the battery block is fastened.

According to this construction, the protruding portion or recessed portion can improve the mechanical strength of the base plate. In addition to this, the sealing member can effectively prevent that the cooling air from flowing into the gap that is formed by the protruding portion or recessed portion. Therefore, it is possible to suppress a reduction in the cooling performance.

In a power supply device according to a fifteenth aspect of the present invention, the separator can include an interposed plate portion that is sandwiched between the battery cells that are disposed adjacent to each other. The interposed plate portion includes cell contact portions, and cell press portions. The cell contact portions are alternately arranged on the opposite sides of the interposed plate portion as viewed in cross-section so that, when the cell contact portions are interposed between the battery cells adjacent to each other, the cell contact portions on one side and the other side alternately come in contact with surfaces of the adjacent battery cells. The cell press portions couple the side edges of the cell contact portions, which are alternately arranged on the opposite sides of the interposed plate portion as viewed in cross-section, to each other. The thickness of the cell press portions is larger than the cell contact portions.

According to this construction, when the battery block is securely held, the bearing performance of the separator can be increased. In addition to this, the contact parts of the separator, which are in contact with the battery cell, can be thin. Therefore, it is possible to improve the heat conduction.

In a power supply device according to a sixteenth aspect of the present invention, a forcedly-gas-blowing mechanism can be further provided which forcedly blows cooling gas to the gas-flowing paths of the battery block thereby cooling the battery cells.

According to this construction, since cooling gas blown by the forcedly-gas-blowing mechanism does not flow through the gap between the battery block and the base plate, it can be ensured that the cooling gas flows through the gas-flowing paths of the battery block. Therefore, it is possible to efficiently cool the battery cells.

A vehicle according to a seventeenth aspect of the present invention includes the aforementioned power supply device. The vehicle further includes a driving electric motor, a vehicle body, and wheels. The driving electric motor is supplied with electric power from the power supply device. The vehicle body accommodates the power supply device and the electric motor. The wheels are driven by the electric motor for vehicle traveling.

According to this vehicle, since the gap between the battery block and the base plate is filled with the sealing member, it is possible to prevent cooling gas from flowing through this gap. In addition, since the separator has the recessed part that holds the sealing member, the sealing member can be arranged in place under the bottom surface of the battery block. In addition, even if vibration during vehicle travelling widens the gap between the battery block and the base plate, the elastically deformable sealing member can close the gap. Therefore, it is possible maintain the airtight sealing performance.

An electric power storage according to an eighteenth aspect of the present invention includes the aforementioned power supply device.

According to this electric power storage, the sealing member that is arranged in a predetermined position of the bottom surface of the battery block can prevent cooling gas from flowing through the gap between the battery block and the base plate. Therefore, the battery cells can be efficiently cooled by the cooling gas, which flows through the gas-flowing paths.

A separator according to a nineteenth aspect of the present invention to be interposed between battery cells thereby electrically insulating the battery cells from each other. The battery cells have a rectangular-box exterior shape, and are to be arranged side by side. The separator includes an interposed plate portion that is to be sandwiched between the battery cells adjacent to each other when the separator is interposed between the battery cells. The interposed plate has recessed parts that form a plurality of gas-flowing paths between the battery cells so that cooling gas can flow along surfaces of these battery cells. The separator further includes a plate-shaped bottom surface cover portion that protrudes in the side-by-side arrangement direction of the battery cells so that, when the separator is sandwiched between battery cells, the bottom surface cover portion can cover the bottom surfaces of the battery cells. The bottom surface cover portion has a groove-shaped recessed part that is formed on the bottom surface of the bottom surface cover portion and extends in the side-by-side arrangement direction of the battery cells so that an elastic sealing member can be held in the groove-shaped recessed part.

According to this construction, a sealing member can be positioned in the recessed part that is formed on the bottom surface of the separator. Therefore, it can be ensured that the sealing member seals the bottom surface side of the separator.

The above and further objects of the present invention as well as the features thereof will become more apparent from the following detailed description to be made in conjunction with the accompanying drawings.

### BRIEF DESCRIPTION OF THE DRAWINGS

FIG. 1 is an external view showing a power supply device according to an embodiment of the present invention;

FIG. 2 is an exploded perspective view showing the power supply device shown in FIG. 1;

FIG. 3 is a partially enlarged, vertical cross-sectional view showing the power supply device shown in FIG. 1;

FIG. 4 is a partially enlarged, vertical cross-sectional view showing a coupling structure for coupling a battery block to a base plate of the power supply device shown in FIG. 3;

FIG. 5 is a perspective view showing the battery block shown in FIG. 2;

FIG. 6 is a partially enlarged perspective view showing the battery block shown in FIG. 5 as viewed from the bottom side;

FIG. 7 is a perspective view showing gas-flowing paths of the battery block shown in FIG. 5;

FIG. 8 is an exploded perspective view showing the battery block shown in FIG. 5;

FIG. 9 is an enlarged cross-sectional view showing the battery block shown in FIG. 4;

FIG. 10 is an enlarged cross-sectional view showing a particular part of the battery block shown in FIG. 9;

FIG. 11 is a partially enlarged, horizontal cross-sectional view showing the battery block shown in FIG. 4;

FIG. 12 is an exploded perspective view showing the side-by-side arrangement of battery cells and separators;

FIG. 13 is a perspective view showing the battery cell to be covered by a heat contraction sheet;

FIG. 14 is an enlarged view showing the bottom part of the battery cell covered with the heat contraction sheet;

FIG. 15 is a perspective view of the separator shown in FIG. 12;

FIG. 16 is a perspective view showing the back surface of the separator shown in FIG. 15 as viewed from the bottom side;

FIGS. 17(a)-(c) are views of the separator shown in FIG. 15, wherein FIGS. 17(a), 17(b), and 17(c) are front, side, and bottom views, respectively;

FIG. 18 is an enlarged bottom view showing the battery block shown in FIG. 5;

FIG. 19 is a schematic view showing a system for cooling the battery blocks by using cooling gas;

FIG. 20 is a block diagram showing an exemplary hybrid car that is driven by an internal-combustion engine and an electric motor, and includes the power supply device;

FIG. 21 is a block diagram showing an exemplary electric vehicle that is driven only by an electric motor, and includes the power supply device;

FIG. 22 is a block diagram a power storage type power supply device to which the present invention is applied;

FIG. 23 is an exploded perspective view showing a battery block included in a known power supply device;

FIG. 24 is a partially enlarged, cross-sectional schematic view showing the side-by-side arrangement in the battery block shown in FIG. 23;

FIG. 25 is a partially enlarged, transverse cross-sectional schematic view showing cooling gas flow in the battery blocks shown in FIG. 23;

FIG. 26 is an exploded perspective view showing the rectangular battery cell to be covered by a heat contraction sheet;

FIG. 27(a) is a perspective view showing the rectangular battery cell shown in FIG. 26 inserted in the heat contraction sheet;

FIG. 27(b) is a perspective view showing the rectangular battery cell shown in FIG. 27(a) with the bottom parts of the heat contraction sheet being welded to each other by heat;

FIG. 28(a) is a front view showing the rectangular battery cell shown in FIG. 27(b) covered by the heat contraction sheet;

FIG. 28(b) is a bottom view showing the rectangular battery cell shown in FIG. 28(a); and

FIG. 28(c) is a side view showing the rectangular battery cell shown in FIG. 28(a).

### DETAILED DESCRIPTION OF THE EMBODIMENT(S)

The following description will describe embodiments according to the present invention with reference to the drawings. It should be appreciated, however, that the embodiments described below are illustrations of a power supply device, a power-supply-device separator, and power-supply-device-equipped vehicle and electric power storage to give a concrete form to technical ideas of the invention, and a power supply device, a power-supply-device separator, and power-supply-device-equipped vehicle and electric power storage of the invention are not specifically limited to the description below. Furthermore, it should be appreciated that the members shown in claims attached hereto are not specifically limited to members in the embodiments. Unless otherwise specified, any dimensions, materials, shapes and relative arrangements of the members described in the embodiments are given as an example and not as a limitation. Additionally, the sizes and the positional relationships of the members in each of the drawings are occasionally shown in enlarged views to facilitate the explanation. Members that are the same as or similar to those of this invention are denoted by the same designation and the same reference signs, and their description is omitted. In addition, a plurality of structural elements of the present invention may be configured as a single part that serves the purpose of a plurality of elements; on the other hand, a single structural element may be configured as a plurality of parts that serve the purpose of a single element. Also, the description of some examples or embodiments may be applied to other examples, embodiments or the like.

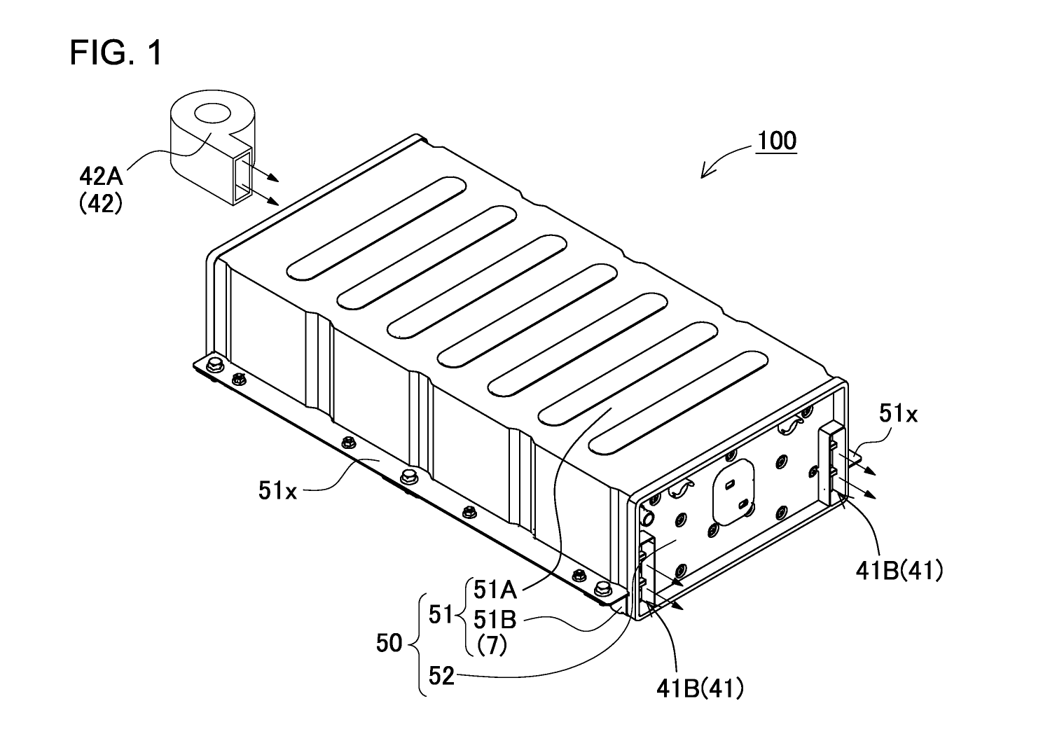

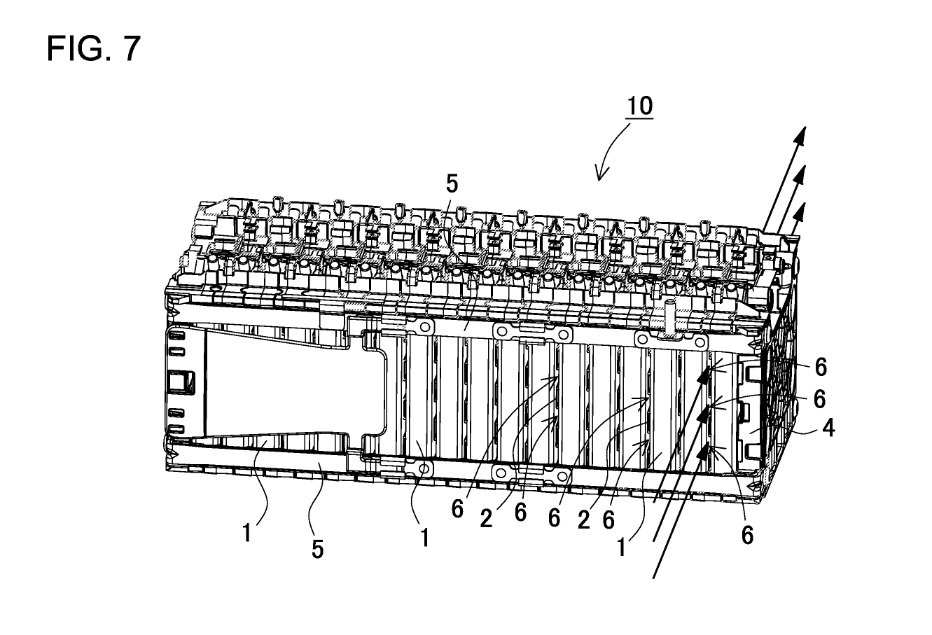

With reference to FIGS. 1 to 12, the following description will describe a vehicle power supply device to which a power supply device according to an embodiment of the present invention is adopted.

The illustrated power supply device is suitable mainly for power supplies of electric vehicles such as hybrid cars that are driven by both an internal-combustion engine and an electric motor, and electric vehicles that are driven only by an electric motor. However, a power supply device according to the present invention can be used for vehicles other than a hybrid car and an electric vehicle. In addition, a power supply device according to the present invention can be used for applications other than electric-type vehicles that require high power, for example, power supplies in stationary electric power storages that charge power supplies with electric power generated by natural power sources such as a solar battery and aerogenerator.

### (Battery Device)

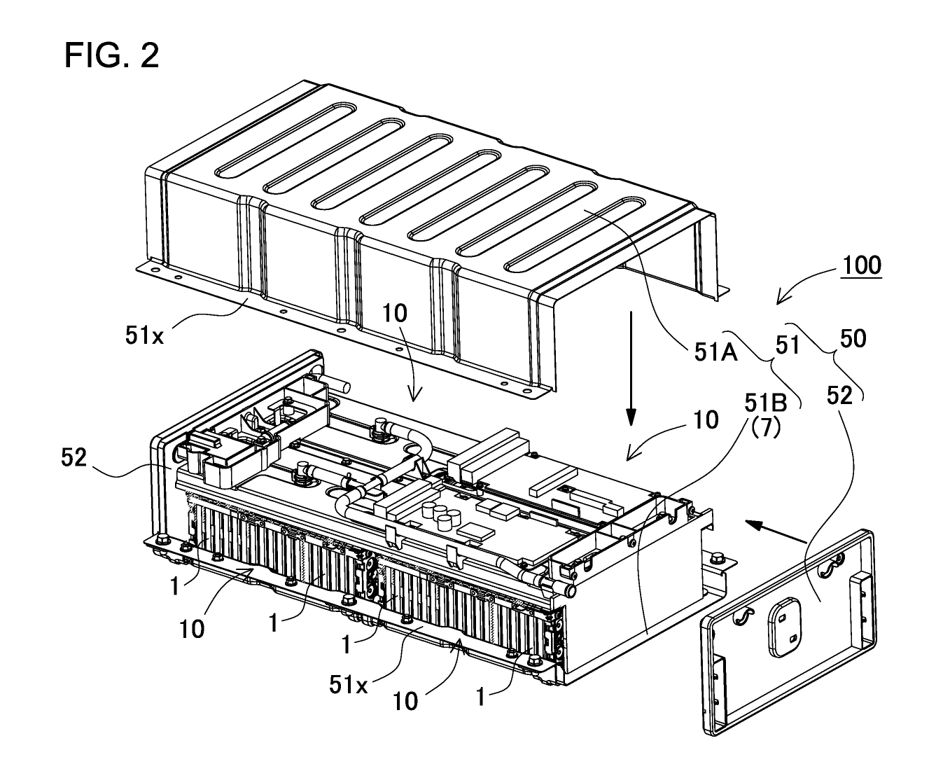

As shown in the perspective view of FIG. 1, a battery device has a box external shape having a rectangular upper surface. This power supply device 100 accommodates one or a plurality of battery blocks 10 in an exterior case 50. The battery block 10 is fastened to the exterior case 50, and is arranged in place. The power supply device shown in the exploded perspective view of FIG. 2 includes four battery blocks 10, which are arranged in two columns and two rows. In addition, the power supply device includes a base plate 7 that has one surface onto which the battery block 10 is fastened. An elastic sealing member 8 is arranged between the bottom surface of the battery block 10 and the upper surface of the base plate 7.

### (Exterior Case 50)

The exterior case 50 include an exterior case portion 51 that includes sectional rectangular U-shaped lower and upper case sections 51B and 51A. The exterior case portion 51 covers the upper and lower surfaces and side surfaces of an assembly of the battery blocks 10. The end surfaces of the exterior case portion 51 are closed by end surface covers 52. In addition, flanges 51x are formed on the longitudinal side surfaces of the exterior case portion 51, and protrude perpendicularly to the longitudinal side surfaces. The flanges 51x facilitate installation of the power supply device on vehicles. The flange 51x has screw holes that are open for receiving screws. Thus, the power supply device can be easily fastened by screws that engage with the screw holes.

### (Base Plate 7)

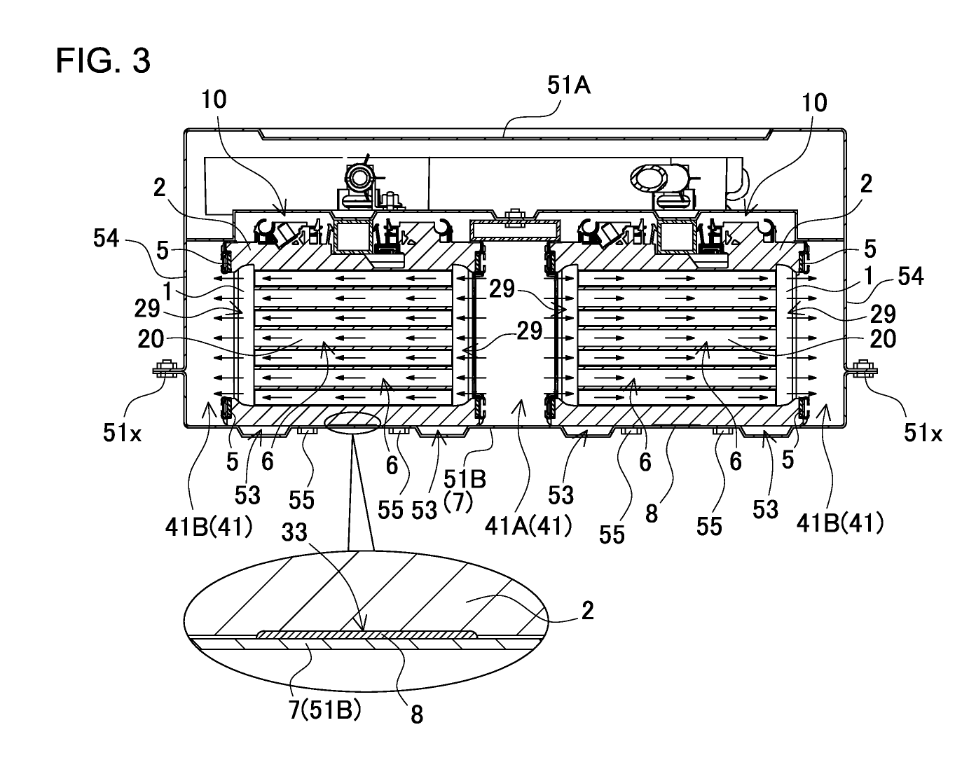

The base plate 7 has a plate shape onto which the battery block 10 can be mounted. The battery block 10 is fastened to the one surface of the base plate 7 so that the battery block 10 is positioned in place. In the power supply device of FIGS. 1 to 4, the lower case section 51B of the exterior case 50 serves as the base plate 7. The battery block 10 is fastened to the upper surface of the lower case section 51B. The illustrated lower case section 51B is formed of a metal plate by presswork, and has a stiffness that can bear the battery block 10 in place after the battery block 10 is fastened to the lower case section 51B. The lower case section 51B shown in FIG. 3 has a protruding portion or recessed portion that is formed in at least a part of the lower case section 51B onto which the battery block is fastened. The lower case section 51B shown in FIG. 3 has a plurality of reinforcement grooves 53 so that protruding portions and recessed portions are formed. The reinforcement grooves 53 can increase the mechanical strength of the base plate 7. However, the base plate is not limited to the lower case section of the exterior case. The base plate may be a plate member separately provided from the lower case section. In this case, this base plate can be accommodated in the exterior case together with the battery block, and the base plate can be arranged in a predetermined position of the exterior case with the battery block being fastened to the upper surface of the base plate, for example. A rigid metal plate, a cooling plate that has a cooling function, or the like can be used as the base plate separately provided from the lower case section.

### (Battery Block)

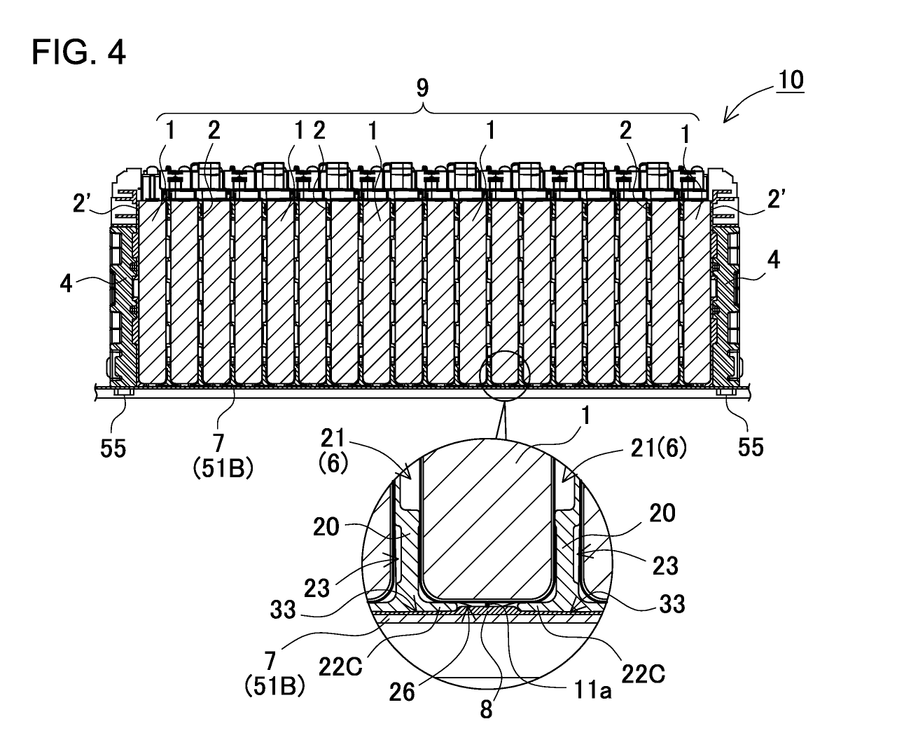

As shown in FIGS. 4 to 12, the battery block 10 includes a plurality of battery cells 1, separators 2, and fastening members 3. The plurality of battery cells 1 has a rectangular box exterior shape. The plurality of battery cells 1 are arranged side by side. The separators 2 are interposed between the battery cells 1. The battery cells 1 and the separators 2 are alternately arranged side by side. The fastening members 3 securely hold a battery assembly 9 of the battery cells 1 and the separators 2. In the illustrated battery block 10, when the rectangular battery cells 1 are arranged side by side, gas-flowing paths 6 are formed. In this power supply device, cooling gas flows through the gas-flowing paths 6 so that the battery cells 1 are cooled.

### (Battery Cell 1)

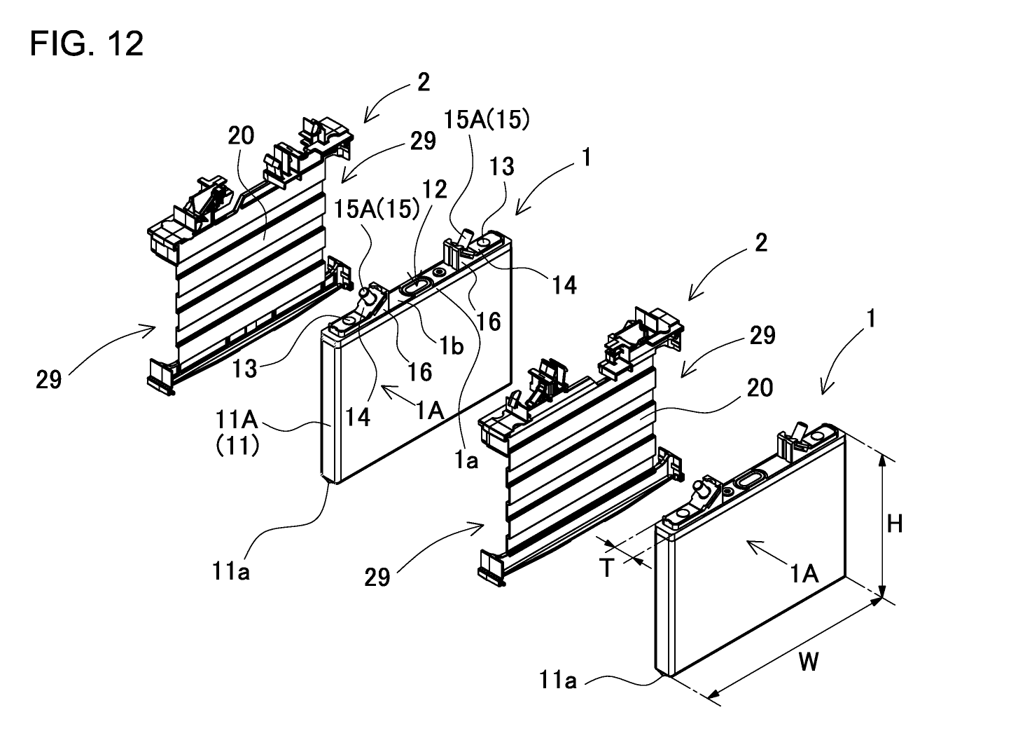

The battery cell 1 is a flat rectangular battery, which has a rectangular box exterior shape the thickness of which is smaller than the width. The rectangular battery cells 1 are arranged side by side, and orientated in parallel to each other. The separators 2 are sandwiched between the battery cells 1. Thus, the battery assembly 9 is constructed of the battery cells 1 and the separators 2. The battery cell 1 is a lithium-ion rechargeable battery. However, the battery cell is not limited to a lithium-ion rechargeable battery. Any rechargeable batteries (e.g., nickel metal hydride batteries) can be also used. The battery cell 1 includes electrode members of positive/negative electrode plates that overlap each other. After the electrode members are accommodated in an exterior container 1a, the exterior container 1a is airtightly sealed. The exterior container la is formed of an upwardly open rectangular box shape, the top opening of which is airtightly closed by a metal sealing plate 1b, as shown in FIG. 12. The exterior container 1a is formed by subjecting a metal plate (e.g., aluminum or aluminum alloy) to deep drawing. The sealing plate 1b is also formed from a metal plate such as aluminum or aluminum alloy similar to the exterior container 1a. After the sealing plate 1b is inserted into the opening of the exterior container 1a, the boundary between the outer periphery of the sealing plate 1b and the inner periphery of the exterior container 1a is subjected to laser beam irradiation. Thus, the sealing plate 1b is fastened to the exterior container 1a by laser welding so that the exterior container 1a is airtightly sealed by the sealing plate 1b.

Positive/negative electrode terminals 13 are secured to and protrude from both side parts of sealing plate 1b, as shown in FIG. 12. The positive/negative electrode terminals 13 are arranged on the upper surface of the sealing plate 1b, and connected to the positive/negative output terminals 15 through connection leads 14, as shown in FIG. 12. Thus, the positive/negative output terminals 15 are connected to the positive/negative electrode plates, which are accommodated in the exterior container, through the connection leads 14 and the electrode terminals 13. The positive/negative output terminals 15 are fastened onto both sides of the upper surface of the sealing plate 1b through terminal holders 16. The positive/negative electrode terminals of the output terminals 15, which are fastened onto the upper surface of the battery cell 1, are arranged horizontally symmetric with respect to the center line. According to this arrangement, in the case where the battery cells 1 are arranged side by side with being flipped from side to side, the positive and negative output terminals 15 of one of the battery cells are serially connected to the negative and positive output terminals 15 of another battery cell adjacent to the one of the battery cells by metal plate bus bars. Alternatively, the positive and negative output terminals 15 of one of the battery cells can be directly serially connected to the negative and positive output terminals 15 of another battery cell adjacent to the one of the battery cells. In the case of the battery block 10 in which the battery cells 1 are serially connected to each other, the output voltage of the battery block can be high, and as a result the battery block can provide high power. Note that, in the battery block according to the present invention, battery cells adjacent to each other may be connected both in parallel and in series to each other.

### (Heat Contraction Bag)

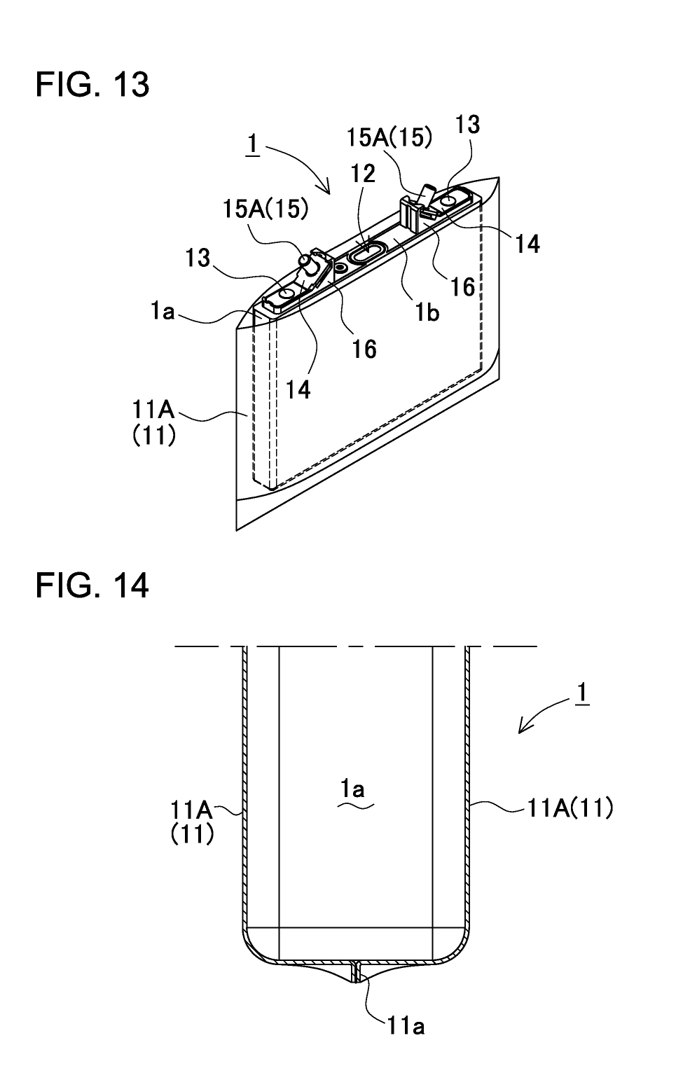

The battery cell 1 includes the exterior metal container 1a so that the metal surfaces of the exterior container 1a are exposed. The surfaces of the battery cell 1 are covered by the electrically insulating covering member 11. The battery cell 1, shown in FIG. 13, is covered by a heat contraction bag 11A that is formed of an electrically insulating sheet (e.g., PET resin sheet) as the electrically insulating covering member 11. After the battery cell 1 is inserted into the tube-shaped heat contraction bag 11A, the heat contraction bag 11A is welded under the bottom surface of the battery cell 1 by heat welding so that the bottom surface of the battery cell 1 is sealed. After that, the heat contraction bag 11A is heated, and brought into tight contact with the surfaces of the battery cell 1. As shown in an enlarged sectional view of FIG. 14, the welded part 11a of the heat contraction bag 11A protrudes from the bottom surface of the battery cell 1, which is covered by the heat contraction bag 11A.

### (Terminal Holder 16)

The terminal holder 16 has a substantially triangular prism shape that has an inclined surface. Thus, the connection lead 14 is arranged in a predetermined position on the electrode terminal 13. The output terminal 15 is fastened onto the connection lead 14. The periphery of the terminal holder 16 on the upper surface of the battery cell 1 is electrically insulated except for the protruding part of the output terminal 15. The output terminal 15 shown in FIG. 12 is a fastening screw 15A. The thread part of this fastening screw 15A passes through the connection lead 14, and protrudes upward from the inclined surface of the terminal holder 16 in a slanting direction. The terminal holder 16 is formed of an electrically-insulating material such as plastic. The output terminal 15 is arranged on the inclined surface of the terminal holder 16. The output terminals 15 are arranged at predetermined positions on both end parts of the battery cell 1, and protrude upward in a slanting direction. The positive/negative electrode terminals 13 are connected to the positive/negative electrode plates, which are accommodated in the exterior container.

### (Separator 2)

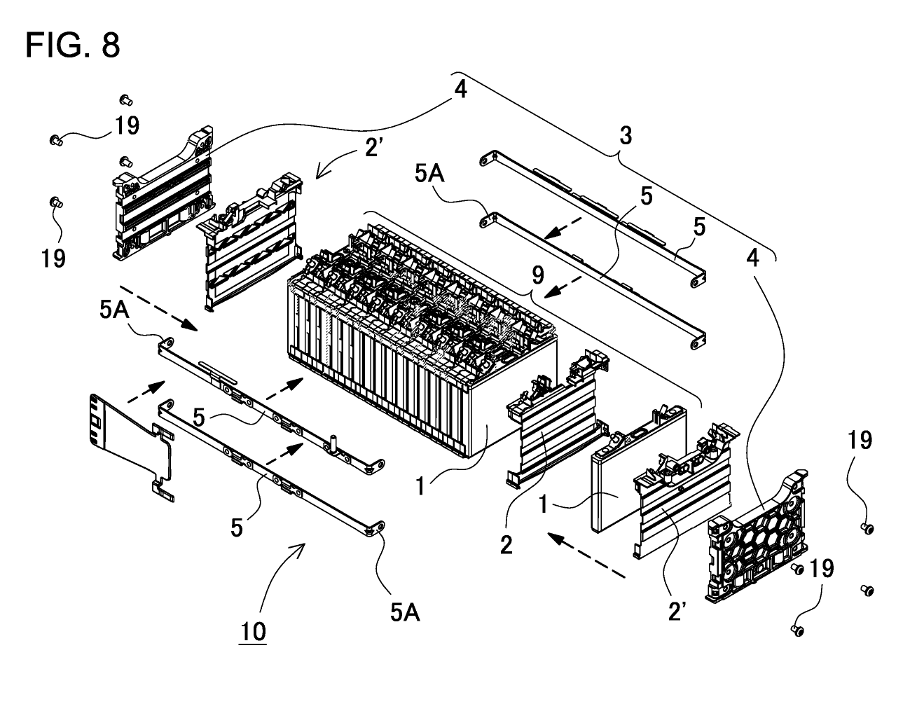

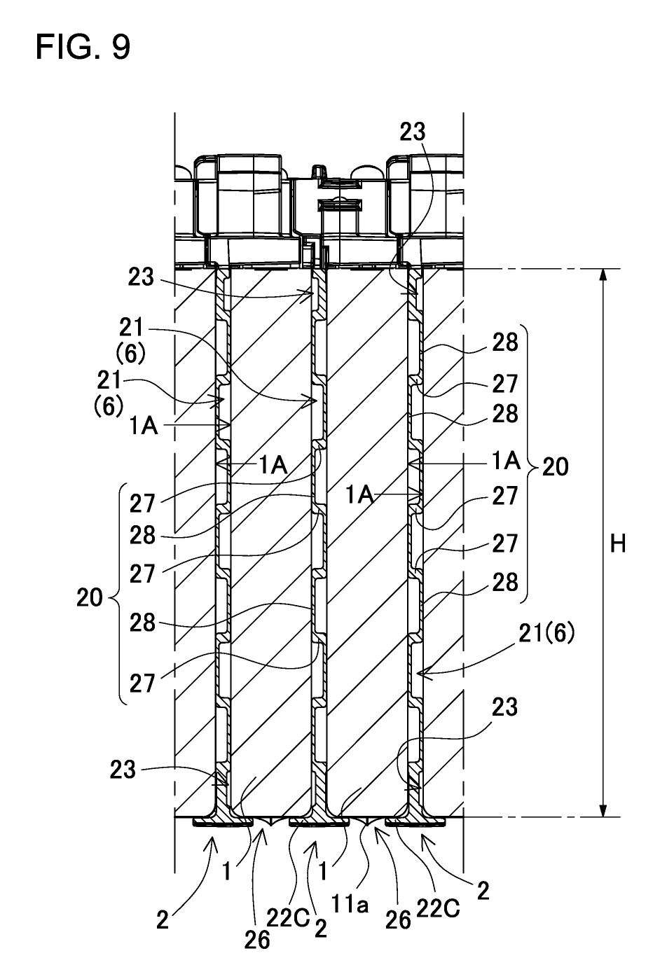

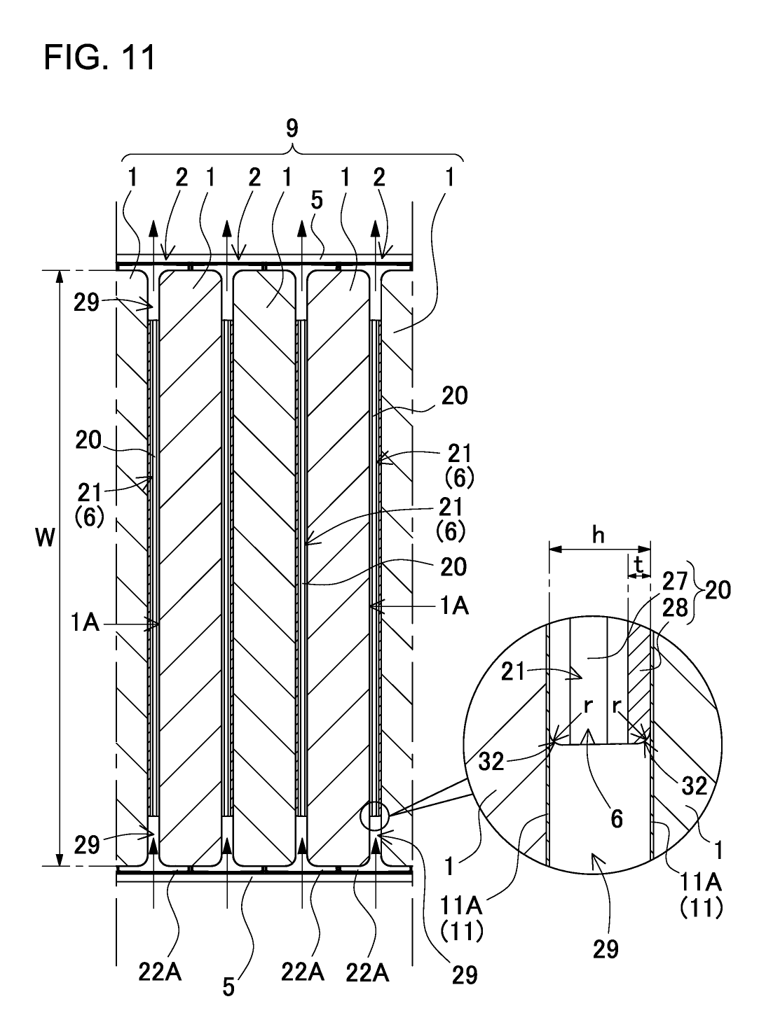

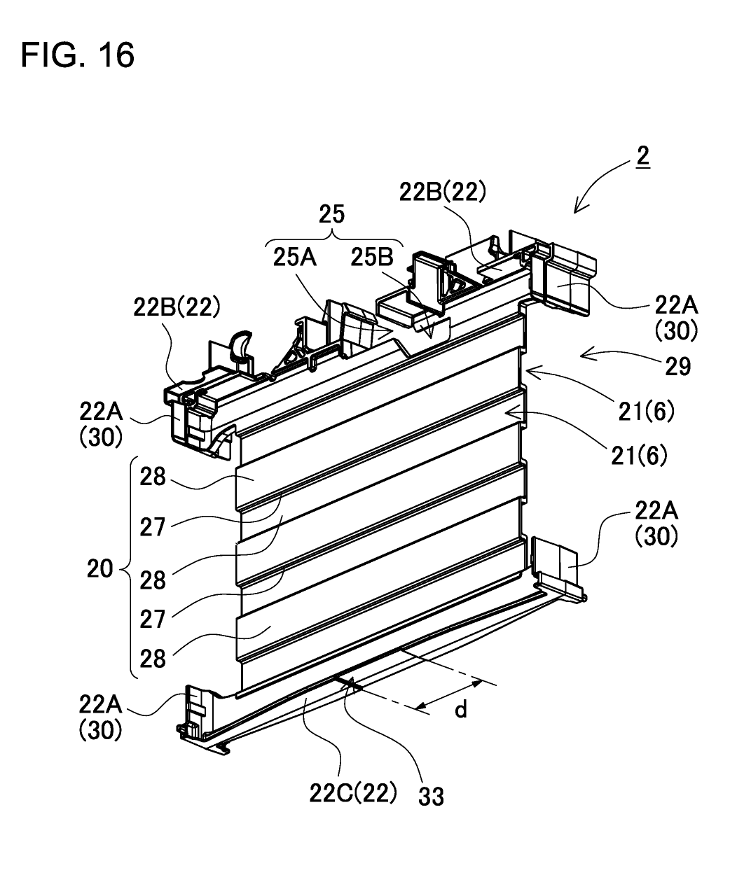

The separator 2 is interposed between the battery cells 1 that are adjacent to each other, as shown in FIGS. 8 to 12. Thus, the adjacent battery cells 1 are spaced at a predetermined interval away from each other, and are electrically insulated from each other. To achieve this, the separator 2 is formed of an electrically insulating material. Thus, the separator 2 electrically insulates the exterior containers 1a of the adjacent battery cells 1 from each other. The separator 2 can be formed of an electrically-insulating material such as plastic by molding. Each of the separators 2 has recessed parts that form the gas-flowing paths 6 between the battery cells 1 so that cooling gas can flow along surfaces of the battery cells 1 when the separator 2 is interposed between the battery cells 1. The separator 2 shown in FIGS. 9 to 12 and 15 to 17 has gas-flowing grooves 21. The gas-flowing grooves 21 are formed on an opposed surface of the separator 2 that is opposed to the battery cell 1. The gas-flowing grooves 21 extend from one side to the other side of the separator 2. Thus, the gaps between the gas-flowing grooves 21 and a main surface 1A of the battery cell 1 serve as the gas-flowing paths 6. As shown in FIGS. 3 and 11, the gas-flowing paths 6 extend in the horizontal direction, and are open on the right and left side surfaces of the battery assembly 9 (battery block 10).

The separator 2 shown in FIGS. 9 to 12 and 15 to 17 includes an interposed plate portion 20 that is sandwiched between the battery cells 1 that are adjacent to each other. The gas-flowing grooves 21 are alternately open on both surface sides of the interposed plate portion 20 so that the gas-flowing paths 6 are formed on both surface sides of the interposed plate portion 20. The gas-flowing paths 6, which are formed on both surface sides of the interposed plate portion 20, extend in straight lines and in parallel to each other. The thus-configured power supply device has a feature that the battery cells 1 on both surface sides of the separator 2 can be effectively cooled by the gas-flowing paths 6, which are formed on the surface sides of the separator 2. However, the gas-flowing grooves may be formed only on one surface side of the separator so that the gas-flowing paths can be formed between the battery cell and the separator.

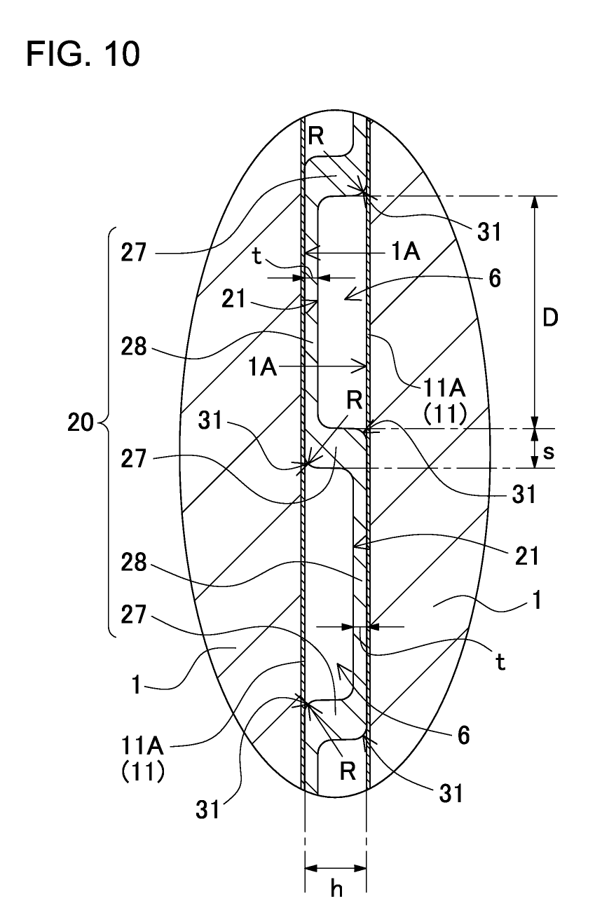

The gas-flowing grooves 21, which are formed on both surface sides of the interposed plate portion 20 of the illustrated separator 2, are sectionally rectangular U-shaped grooves. The interposed plate portion 20 has a rectangular wave shape as viewed in section. As shown in the enlarged cross-sectional view of FIG. 10, the interposed plate portion 20 includes a plurality of cell press portions 27, and a plurality of cell contact portions 28. The cell press portions 27 are sandwiched between the battery cells 1 that are adjacent to each other when the battery assembly 9 is securely held. The cell contact portions are in contact with the main surfaces 1A of the opposed battery cells 1. In other words, the interposed plate portion 20 includes cell contact portions 28, and cell press portions 27. The cell contact portions 28 are alternately arranged on the opposite sides of the interposed plate portion as viewed in cross-section so that, when the cell contact portions 28 are interposed between the battery cells 1 adjacent to each other, the cell contact portions 28 on one side and the other side alternately come in contact with surfaces of one and the other of the adjacent battery cells 1. The cell press portions 27 couple the side edges of the cell contact portions 28, which are alternately arranged on the opposite sides of the interposed plate portion 20 as viewed in cross-section. The cell press portions 27 are formed in a rib shape that extends in the longitudinal direction of the gas-flowing groove 21, and serve as the side walls of the gas-flowing grooves 21. The cell contact portion 28 is formed in a narrow plate shape that extends in the longitudinal direction of the gas-flowing groove 21. Thus, the cell contact portion 28 forms the bottom plate of the gas-flowing groove 21 that is open toward the side of the interposed plate portion 20 opposite to the cell contact portion. The cell press portions 27 are coupled to each other by the cell contact portions 28, which are arranged alternately on the surface sides of the illustrated interposed plate portion 20, so that the interposed plate portion 20 has a rectangular wave shape as viewed in section. Thus, the gas-flowing paths 6 are alternately formed on the surface sides of the interposed plate portion 20 of the illustrated separator 2. In other words, the cell press portions 27 are coupled to each other by the cell contact portions 28, which are alternately arranged on the surface sides of the interposed plate portion, so that the interposed plate portion has recessed parts (sectionally U-shaped grooves that are alternately open on both surface sides of the interposed plate portion).

After the separators 2 are arranged side by side between the battery cells 1 that are adjacent to each other, when the battery assembly 9 is securely held from both end surface sides, the surface sides of the cell press portions 27 are brought into contact with and are pressed by the main surfaces 1A of the adjacent battery cells 1 that are opposed to the surface sides of the cell press portions 27. Thus, the openings of the gas-flowing grooves 21 of the separator 2 are closed by the main surface 1A of the battery cell 1 opposed to the separator 2 so that the gas-flowing paths 6 are formed by the gas-flowing grooves 21, while the cell contact portions 28, which are located on the opposite side to the openings of the gas-flowing grooves 21 and serve as the bottom plates of the gas-flowing grooves 21, are in contact with and pressed by the main surface 1A of this battery cell 1. According to this separator 2, since the vertical width of the cell contact portion 28, which is wider than that of the cell press portion 27 (in a vertical direction in FIG. 10) and is in contact with the main surface 1A of the battery cell 1, the contact surface area between the separator 2 and the battery cell 1 can be enlarged. As a result, it is possible to reduce pressure that is applied onto the exterior container 1a of the battery cell 1.

It is preferable that the thickness (s) of the cell press portion 27 of the interposed plate portion 20 be larger than the thickness (t) of the cell contact portion 28. According to this construction, since contact parts of the separator 2 can be in contact with large areas of the battery cell 1, it is possible to improve the thermal conductivity of these contact parts. Also, since the bearing parts of the separator 2 are thick, the bearing parts of the separator 2 can have a high degree of stiffness. As a result, the bearing parts of the separator 2 can apply sufficient forces to prevent the separator 2, which is sandwiched between the battery cells 1, from collapsing. In the case where the separators 2 are arranged side by side on the battery cells 1 that have a width (W) of 120 mm, and a height (H) of 85 mm, the height (h) of the cell press portion 27 corresponding to the thickness of the interposed plate portion 20, the thickness (s) of the cell press portion 27, and the thickness (t) of the cell contact portion 28 are set to 2.3 mm, 1.5 mm, and 0.5 mm, respectively. In addition, the interval between the cell press portions 27, that is, the width (D) of the gas-flowing path 6 is set to 8.5 mm.

Also, the edge parts of the separator 2 that form the gas-flowing paths 6 are rounded. As shown in the enlarged cross-sectional view of FIG. 10, the opening edges of the gas-flowing grooves 21 of the separator 2 are rounded. The opening edges of the gas-flowing grooves 21 extend along the longitudinal direction of the gas-flowing grooves 21, and can be in contact with the main surface 1A of the battery cell 1. In other words, the corners of the cell press portion 27 of the separator 2 are rounded. The cell press portion 27 forms the side wall of the gas-flowing groove 21. The illustrated rounded part 31 is formed in a curved surface having a predetermined curvature radius (R). However, the rounded part is not limited to the curved surface, but can be a bevel.

In addition, as shown in the enlarged cross-sectional view of FIG. 11, the opening end edges of the gas-flowing grooves 21 of the separator 2 are rounded. The opening end edges of the gas-flowing groove 21 are the edges of horizontal opened ends of the gas-flowing groove 21, and can be in contact with the main surface 1A of the battery cell 1. In other words, the corners of the side ends of the cell contact portion 28 of the separator 2 are rounded. The corners of the side ends of the cell contact portion 28 are the corners of the both ends of the cell contact portion 28, and can be in contact with the main surface 1A of the battery cell 1. The illustrated rounded part 32 is formed in a curved surface having a predetermined curvature radius (r). However, the rounded part is not limited to the curved surface, but can be a bevel.

As discussed above, in the case where the gas-flowing grooves 21 are arranged in the surface of the separator 2 so that the gas-flowing paths 6 are formed between the gas-flowing grooves 21 and the main surface 1A of the battery cell 1 opposed to the gas-flowing grooves 21, since the edge parts of the separator 2 that form the gas-flowing paths 6 are rounded, it is possible to effectively prevent the covering member 11 for covering the battery cell 1 surface from being damaged. In particular, even when the battery assembly 9 is securely held by a strong force of the fastening member 3, or even when the surface of the separator 2 is pressed onto the surface of the battery cell 1 by a strong force of expansion of the battery cell 1, or the like, it is possible to prevent the covering member 11 for covering battery cell 1 surfaces from being damaged by the edge parts of the separator 2. As a result, it can be ensured that the covering member 11 of the battery cell 1 is protected. Therefore, the battery cell 1 can be held electrically insulated for a long time.

In addition, cutout-shaped areas 29 are formed on both side parts of the separator 2 shown in FIGS. 3, 11 and 15 to 17 so that the open ends of the gas-flowing path 6 are open at positions inside the side surfaces of the battery assembly 9. In the illustrated interposed plate portion 20, the cutout-shaped areas 29 are formed in a cutout shape in parts in proximity to the side surfaces of the battery assembly 9 so that the battery cell 1 is exposed in these parts. Since the cutout-shaped areas 29 are formed on the side parts of the separator 2 so that the side parts other than the corner parts of the separator 2 are located inside the side edges of the main surface 1A of the battery cell 1, the inlet and outlet of the gas-flowing path 6 can be large although the strength of the separator 2 can be maintained. As a result, it is possible to suppress turbulent flow or the like, and to reduce pressure loss caused by turbulent flow. In particular, in the case where the cooling gas flows through the later-discussed gas-flowing duct, and is guided into narrow slits, the loss will be large. In addition, when the cooling gas flow turns from the side-by-side arrangement direction of the battery cells 1 to a direction perpendicular to this side-by-side arrangement direction, the loss will be also large. To prevent this, the cutout-shaped area 29 is formed on the inlet side of the separator 2 so that sufficient space is surely provided on the inlet sides of the gas-flowing paths 6. According to this construction, the cooling gas can be temporarily held in this space, and then guided into the gas-flowing paths 6. As a result, the pressure loss can be reduced. Therefore, the cooling gas can be more smoothly guided. In addition, since a large cutout-shaped area is also open on the outlet side of the separator, the pressure loss can be reduced. In particular, although the cutout-shaped areas 29 are formed on both sides of the interposed plate portion 20 of the separator 2, since the edge parts on the ends of the part of the separator 2 that are open at positions inside the side surfaces of the battery assembly 9 are rounded, it is possible to effectively prevent these end parts of the covering member for the battery cell surface from being damaged.

Since the cutout-shaped areas 29 are formed in the separator 2 in a cutout shape that corresponds to a shape obtained by cutting out band-shaped parts of constant width from the side edge of the separator 2, a large area of the main surface of the battery cell 1 can be covered by the separator 2. Accordingly, electric insulation between the battery cells 1 can be maintained. The exposed parts of the exterior container 1a that are exposed through the cutout-shaped areas 29 are located on both side parts of the exterior container 1a. The strength of the side parts of the exterior container 1a is relatively high. For this reason, even when the battery cell 1 expands to some extent, deformation of the side parts of the exterior container 1a is relatively small. As a result, it is possible to prevent the battery cells 1 from coming into contact with each other.

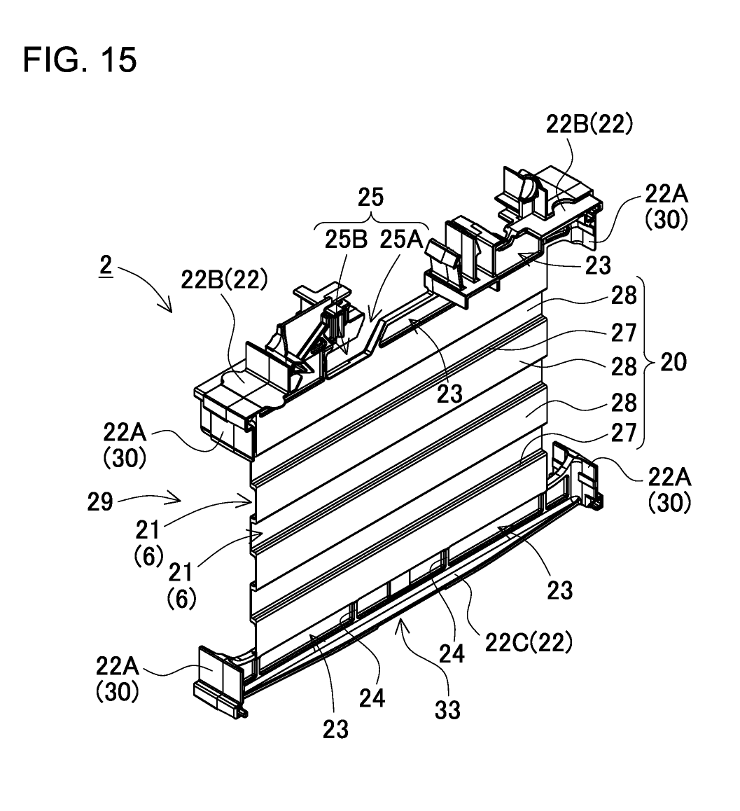

As shown in FIGS. 15 to 17, the separator 2 has peripheral walls 22 that are arranged outside the interposed portion 20, and protrude in the side-by-side arrangement direction of the battery cells 1. The peripheral walls 22 of the separator 2 have substantially the same inner shape as the exterior shape of the battery cell 1. According to this construction, when the battery cells 1 are held in the peripheral walls 22, the separator 2 can be arranged in place. The peripheral walls 22 can hold the battery cells 1 by a fit-in structure. Specifically, the battery cells 1 are fitted in the peripheral walls 22 on both surface sides of the separator 2. Thus, adjacent battery cells 1 are arranged side by side without positional deviation by the separator 2 that holds the battery cells 1 by using the fit-in structure. The peripheral wall 22 includes vertical and upper peripheral wall portions 22A and 22B, and a bottom cover portion 22C. The vertical peripheral wall portions 22A can be located outside the side surfaces of the battery cell 1. The upper peripheral wall portions 22B can be located outside the upper surface of the battery cell 1. The bottom cover portion 22C can be located outside the bottom surface of the battery cell 1.

The vertical peripheral wall portion does not continuously extend from the upper side end to the lower side end of the separator 2, but the vertical peripheral wall portions 22A are arranged on the upper and lower side end parts of the separator. Thus, an opening is formed between the upper and lower side end parts of the separator so that cooling gas can be forcedly blown into the space between the separator 2 and the battery cell 1. In the illustrated separator 2, the vertical peripheral wall portions 22A are arranged along the side edges on the upper and lower parts (i.e., except the cutout-shaped areas) of the interposed plate portion 20, and integrally formed with the interposed plate portion 20. The vertical peripheral wall portion 22A that is arranged on the upper side end part of the separator 2 is coupled at a right angle to the upper peripheral wall portion 22B. The vertical peripheral wall portion 22A that is arranged on the lower side end part of the separator 2 is coupled at a right angle to the bottom cover portion 22C on the bottom surface side of the separator 2. The vertical peripheral wall portions 22A have a width that allows two separators to cover the overall width of the side surfaces of one of the battery cells 1 when the separators are interposed between the battery cells 1. The protruding amount of the vertical peripheral wall 22A in the side-by-side arrangement direction of the battery cells 1 is a half of the thickness of the battery cell 1 so that two vertical peripheral wall portions 22A can cover the overall width of the side surfaces (i.e., the thickness) of the battery cell 1.

The vertical peripheral wall portions 22A cover the side surfaces of the battery cell 1 so that this battery cell 1 is positioned in the horizontal orientation. The vertical peripheral wall portions 22A also serve as electrically insulating wall portions 30 that are arranged between the later-discussed bind bars 5 and the exterior surfaces of the battery cells 1, and electrically insulate the bind bars 5 and the battery cells 1 from each other. The bind bars 5 extend along the side surfaces of the battery assembly 9. The vertical peripheral wall portions 22A as the electrically insulating wall portions 30 are arranged between the exterior surfaces of the battery cells 1 and the bind bars 5. The vertical length of the vertical peripheral wall portion 22A as the electrically insulating wall portions 30 is equal to or longer than the width of the bind bar. The overall width of the bind bar 5 can be entirely electrically insulated by the electrically insulating wall portions 30 of the separators 2. Thus, the battery cells 1 can be ideally electrically insulated from the bind bars 5. However, it is not necessary that the vertical length of the electrically insulating wall portion be equal to or longer than the width of the bind bar. The reason is that, when the electrically insulating wall portion is arranged between the exterior surfaces of the battery cells and the bind bars, gaps can be formed between the exterior surfaces of the battery cells and the bind bars, and can electrically insulate the battery cells from the bind bars.

The thickness of the electrically insulating wall 30 of the separator 2 is small, preferably about 0.5 mm. This separator 2 can reduce the gap between the bind bar 5 and the battery cell 1 so that the surface of the battery cell 1 can be arranged close to the bind bar 5. In this case, the heat can be efficiently dissipated from the side surfaces of the battery cells 1 through the bind bars 5. In particular, in the case where the bind bar 5 is formed of a metal band having a large width, the heat can be more effectively dissipated. In the case where the electrically insulating wall portions 30 of the separator have a vertical length that is larger than the width of the bind bar 5, even when the electrically insulating wall portions are thin, the battery cells can be reliably electrically insulated from the bind bars. From this viewpoint, even when the thickness of the wide electrically insulating wall portions of the separator 2 is smaller than 0.5 mm, for example, not smaller than 0.3 mm and smaller than 0.5 mm, the battery cells can be electrically insulated from the bind bars. On the other hand, in the case where the electrically insulating wall portions are thick, for example, have a thickness in the range of 0.5 to 2 mm (preferably, 0.5 to 1 mm), even when the vertical length of the electrically insulating wall portions is smaller than the width of the bind bars, the battery cells can be electrically insulated from the bind bars. The reason is that the gaps between the exterior surfaces of the battery cells and the bind bars are large.

The upper peripheral wall portion 22B has a shape that does not overlap the output terminals 15 and an opening 12 of a safety valve that are arranged on the upper surface of the battery cell 1 thereby exposing the output terminals 15 and the opening 12 of the safety valve. In addition, the separator 2, shown in FIGS. 15 to 17, has a guide recessed portion 25 that is formed in the upper part of the separator 5 but on the lower side relative to the upper peripheral wall portion 22B. The guide recessed portion 25 accommodates a temperature sensor (not shown) that detects the cell temperature of the battery cell 1. This guide recessed portion 25 includes an insertion section 25A, and an accommodation section 25B. The insertion section 25A is opened upward in a direction diagonally intersecting with the upper edge of the separator 2. The accommodation section 25B communicates with the insertion section 25A, and extends in the horizontal direction. The temperature sensor is inserted through the insertion section 25A into the accommodation section 25B of the guide recessed portion 25 so that a temperature-detecting portion (not shown) is accommodated in the accommodation section 25B. Since the guide recessed portion 25 is located on the lower side relative to the upper peripheral wall portion 22B of the separator 2, the temperature-detecting portion of the temperature sensor is positioned at a predetermined depth from the upper surface of the battery cell 1 when accommodated in the accommodation section 25B. Since the accommodation section 25B extends in the horizontal direction, the temperature-detecting portion can be positioned at a constant depth from the upper surface of the battery cell 1 wherever the temperature-detecting portion is placed in the accommodation section 25B. According to this guide recessed portion 25, the temperature-detecting portions can be accurately positioned at the same depth from the upper surfaces of the battery cells 1.

As discussed above, the temperature-detecting portion of the temperature sensor is positioned lower than the upper surface of the battery cell 1 by the separator 2. However, the temperature-detecting portion of the temperature sensor may be positioned on the upper side relative to the upper surface of the battery cell by the guide recessed portion of the insertion section and the accommodation section. In this separator, the accommodation section can be located at a position corresponding to the upper surface of the battery cell so that the temperature-detecting portion can be positioned on the upper surface of the battery cell when accommodated in the accommodation section.

The bottom cover portion 22C is located on the bottom surface side of the separator 2, and protrudes in the side-by-side arrangement direction of the battery cells 1, i.e., in the horizontal direction. When battery cells 1 and the separators 2 are arranged side by side, the bottom surface cover portion 22C covers half parts of the bottom surfaces of the battery cells 1 opposed to the separators 2 so that the bottom surfaces of the battery cells 1 can be held in place. In order to hold the battery cells 1 on both surface sides of the interposed plate portion 20 of the separator 2 of FIGS. 4, 9, and 15 to 18, the bottom surface cover portion 22C protrudes from the lower end edges of both surface sides of the interposed plate portion 20. The bottom surface cover portion 22C is formed integrally with the interposed plate portion 20. Bottom surface openings 26 are formed between the bottom surface cover portions 22C of the separators 2 that are adjacent to each other. The bottom surface opening 26 accommodates the welded part 11a of the heat contraction bag 11A, which covers the battery cell 1. In other words, when the battery cell 1 is sandwiched between adjacent separators 2, the welded part 11a of the heat contraction bag 11A, which protrudes from the bottom surface of the battery cell 1, is arranged in the bottom surface opening 26. It is preferable that the thickness of the bottom surface cover portion 22C be greater than the protruding amount of the welded part 11a. In this case, it is possible to prevent the welded part 11a of the heat contraction sheet 11A from protruding outward of the bottom surface of the separator 2.

### (Bottom Surface Opening 26)

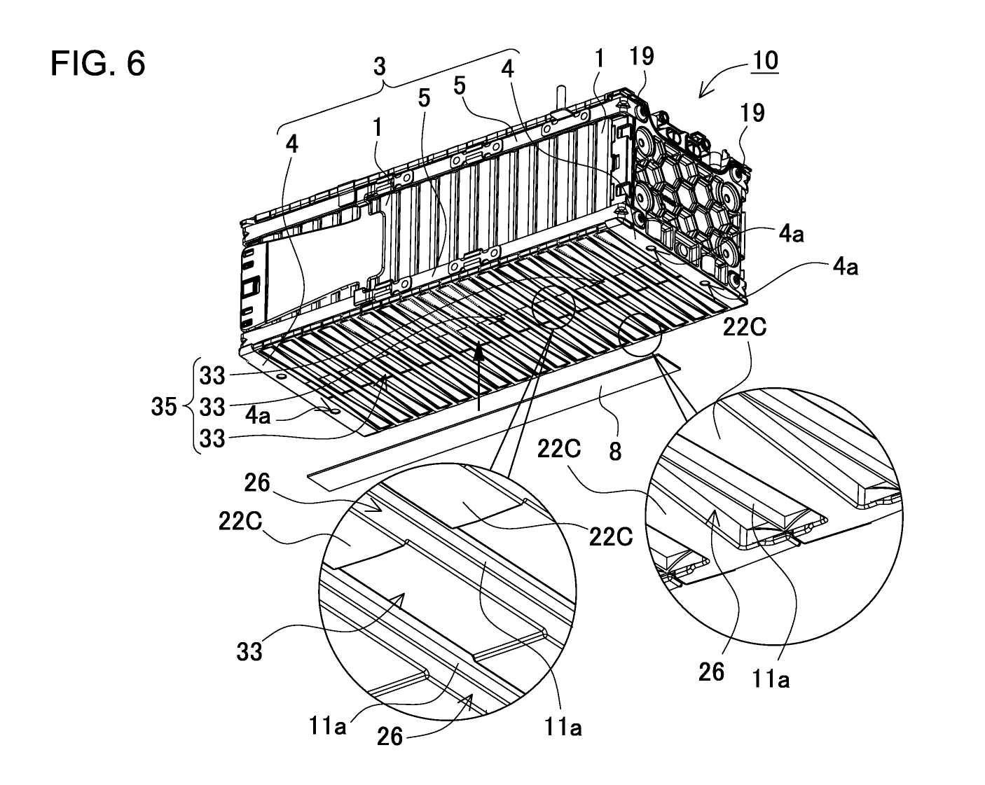

As shown in FIGS. 6, 9, and 18, the bottom surface opening 26 is defined as the gap that is formed between the bottom surface cover portions 22C, which are adjacent to each other when the battery cell 1 is sandwiched between the separators 2 which are adjacent to each other. When the bottom surface opening 26 is formed between the opposed bottom surface cover portions 22C, the bottom surface opening 26 is open right under the welded part 11a, which protrudes from the bottom surface of the battery cell 1. The welded part 11a of the heat contraction sheet 11A for covering the battery cell 1 extends substantially along the center line of the bottom surface of the battery cell 1 that divides the bottom surface of the battery cell 1 into halves in the thickness direction of the battery cell 1. Correspondingly, the bottom surface opening 26 is open right under the center line m that divides the bottom surface of the battery cell 1 into halves in the shorter edge direction of the bottom surface of the battery cell 1, and extends along the longitudinal direction of the bottom surface of the battery cell 1. According to the bottom surface opening 26 in this arrangement, even in the case where the opening area of this bottom surface opening 26 is small, it can be ensured that the welded part 11a of the heat contraction sheet 11 is guided into the bottom surface opening 26. In addition, the bottom surface opening 26 that extends along the longitudinal direction of the bottom surface of the battery cell 1 can open from one side edge to the other side edge of the battery cell 1. In this case, even in the case where the welded part 11a extends along the entire length (from one side edge to the other side edge) of the bottom surface of the battery cell 1, the welded part 11a can be guided into the bottom surface opening 26.

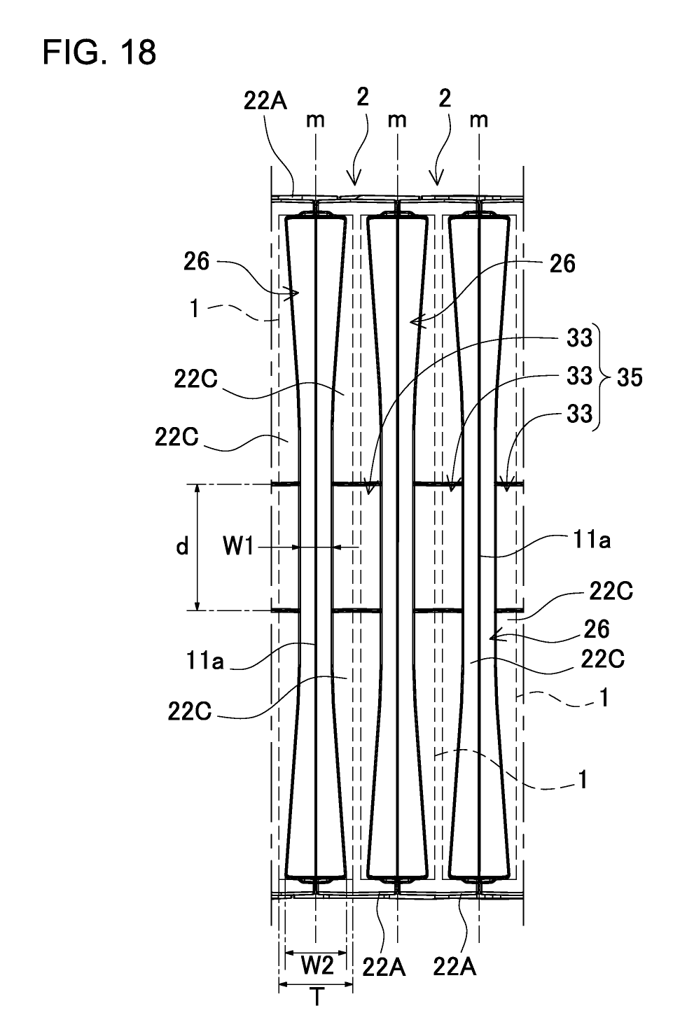

The opening width (w) of the bottom surface opening 26, shown in FIGS. 6 and 18, is wider on the side ends than at the center of the bottom surface opening 26. The opposed edges of the illustrated bottom surface cover portions 22C that are opposed to each other have a convex shape that protrudes in the center of the bottom surface cover portion 22C as viewed from the bottom surface side so that the opening width of the bottom surface opening 26 is wider on both side ends than at the center of the bottom surface opening 26. The opposed central edge parts of the bottom surface cover portions 22C shown in FIG. 18 extend substantially in parallel to each other, while the side edge parts of the bottom surface cover portions 22C are inclined so that the opening width of the bottom surface opening 26 is wider on the side ends than at the central part of the bottom surface opening 26. The opposed edges of the bottom surface cover portions of the separators that are opposed to each other may have a curved convex shape that protrudes in the center of the bottom surface cover portion as viewed from the bottom surface side so that the opening width of the bottom surface opening is wider on the side ends than at the center of the bottom surface opening. The center opening width (w1) of the bottom surface opening 26 according to this embodiment shown in FIG. 18 is set not greater than two-thirds the thickness (T) of the battery cell 1, and is preferably set to the range of one-fifth to one-half the thickness (T) of the battery cell 1. Also, the side end opening width (w2) is set not greater than one-half the thickness (T) of the battery cell 1, and preferably set to the range of two-thirds to the same as the thickness (T) of the battery cell 1.

According to the separators 2, when the battery cell 1 is held in place inside the peripheral wall portions 22, the welded part 11a is guided into the bottom surface opening 26. As a result, it is possible to prevent the heat contraction bag 11A from being nipped by the separators 2. In particular, in the case where the battery cell 1 is covered by the heat contraction bag 11A with the welded part 11a being formed on the bottom surface of the battery cell 1 as shown in FIG. 14, the width of the side ends of the welded part 11a is likely to be larger than in the central part. For this reason, in the case where the opening width (w) of the bottom surface opening 26 between the separators 2 gradually increases from the central part to the sides, the welded part 11a can be reliably guided into the bottom surface opening 26. As a result, it is possible to prevent the heat contraction bag 11A from being nipped by the separators 2. In addition, since the opposed edges of the bottom surface cover portions 22C that are opposed to each other have a convex shape that protrudes in the center of the bottom surface cover portion 22C as viewed from the bottom surface side, the area of the bottom surface cover portion 22C can be large. Therefore, the bottom surface of the battery cell 1 can be securely held by the bottom surface cover portions 22C.

### (Recessed Part 33)

The bottom surface cover portion 22C has a recessed part 33 that is formed on the bottom surface side of the separator. The recessed part 33 can hold the sealing member 8, which is interposed between the bottom surface of the battery block 10, and the upper surface of the base plate 7. The recessed part 33, shown in FIGS. 6 and 16 to 18, has a groove shape that extends in the side-by-side arrangement direction of the battery cells 1. The groove-shaped recessed part 33 opens and extends from one edge to the other edge of the bottom surface cover portion 22C. In the illustrated separator 2, the groove-shaped recessed part 33 is formed in the central part of the bottom surface cover portion 22C. According to this construction, in the case where the separators 2 that have the same shape are arranged side by side with being flipped from side to side, since the groove-shaped recessed parts 33 are arranged in the central part of the bottom surface of the battery block 10, the groove-shaped parts 33 can be aligned in a straight line. Since the groove-shaped recessed parts 33 are formed in the central parts of the bottom surface cover portions 22C, the sealing member 8 is arranged in the groove-shaped recessed part 33 in the central part of surface cover portion 26, which reduces the opening width (w) of the bottom surface opening 26. As a result, it is possible to reduce air leakage through the bottom surface opening 26, and additionally to efficiently close the gap between the battery block 10 and the base plate 7. In the illustrated separator 2, the opening width (d) of the groove-shaped recessed part 33 is set to the range of one-eighth to one-half the width (W) of the battery cell 1, preferably, to one-sixth to one-fourth the width (W) of the battery cell 1. The opening width (d) of the groove-shaped recessed part 33 is substantially equal to the width of the sealing member 8. Also, the depth of the groove-shaped recessed part 33 is set to the range of one-tenth to one-half the thickness of the bottom surface cover portion 22C, and preferably, to the range of one-fifth to one-third the thickness of the bottom surface cover portion 22C. In this case, the sealing member 8 can be positioned in place.

When the separators 2 are arranged side by side, the groove-shaped recessed parts 33, which are formed on the bottom surface cover portions 22C of the separators 2, are aligned in a straight line on the bottom surface of the battery block 10 so that the sealing member 8 is held in a straight groove portion (these aligned groove-shaped parts) 35. After the groove-shaped recessed parts 33 are aligned in a straight line, one elongated sealing member 8 is held in the straight groove portion 35, as shown in FIG. 6. Thus, the sealing member 8 can efficiently close the gap between the battery block 10 and the base plate 7. Since the sealing member 8 can be smoothly held in the boundary part between adjacent separators 2, it is possible to airtightly seal the boundary part. Since the straight groove portion 35 is formed on the bottom surface of the battery block 10, the entire sealing member 8 can be evenly held in thickness. Therefore, the battery block 10 can be evenly held in height.

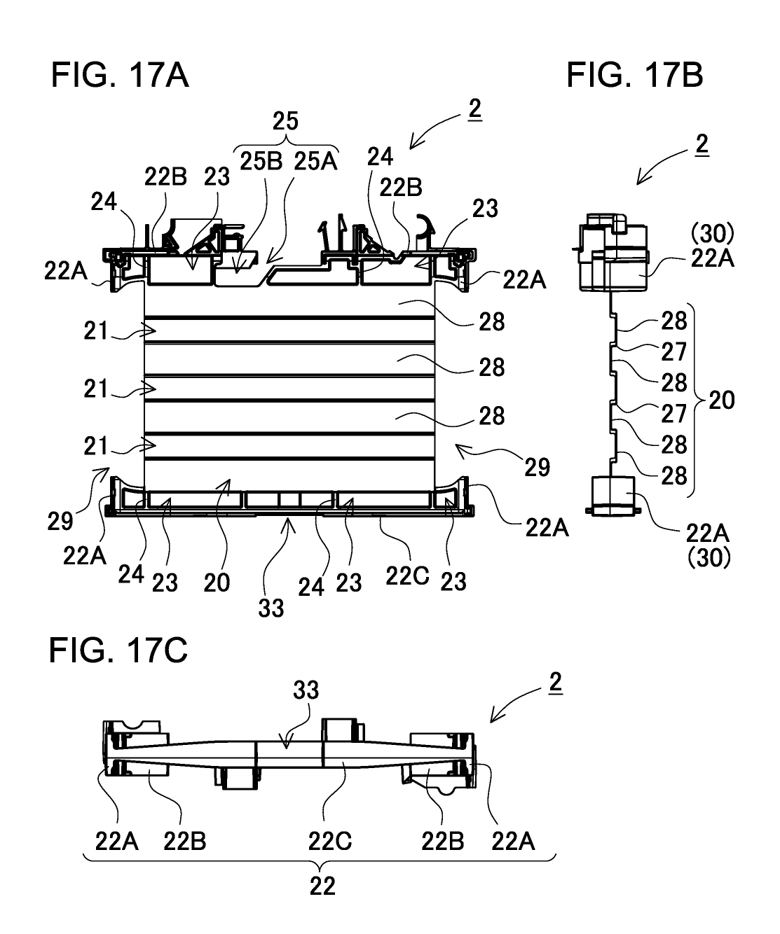

In addition, the separator 2, shown in FIGS. 9, 15, and 17, has stress-relief recessed portions 23 that are formed on both side parts of the interposed plate portion 20, which is sandwiched between the battery cells 1. The side parts are parts that are opposed to a sealing portion on the upper side of the battery cells, and parts that are opposed to the bottom part on the lower side of the battery cells. The illustrated stress-relief recessed portions 23 are recessed parts that are formed on opposed parts of the interposed plate portion 20 opposed to the battery cells 1, and are grooves having a small depth. In the separator 2 shown in FIGS. 15 and 17, a plurality of stress-relief recessed portions 23 extend along the upper and lower edges of the battery cell 1, in other words, in the right-and-left direction in FIGS. 15 and 17. The partitioning wall portions 24 are arranged between the stress-relief recessed portions 23 adjacent to each other. The partitioning wall portion 24 has a height that allows the end surfaces of the partitioning wall portion 24 to contact the main surface 1A of the battery cell 1 so that the battery cell 1 opposed to the separator can be pressed and supported by the partitioning wall portions 24. In the illustrated separator 2, the stress-relief recessed portions 23 are formed on only one of the surface sides of the interposed plate portion 20. However, the separator can have the stress-relief recessed portions on both of the surface sides of the interposed plate portion 20.

According to this separator, after the battery cells 1 are arranged between the interposed plate portions 20 of the separators 2 adjacent to each other so that the battery cells 1 and the separators 2 are alternately arranged side by side, when the battery cells 1 and the separators 2 are securely held from both end surfaces of the battery assembly by the fastening members 3, it is possible to prevent a stress from being locally applied to the upper and lower parts of the battery cells 1. The reason is that, after the battery cells 1 are sandwiched by the interposed plate portions 20 of the separators 2, when the battery assembly is pressed by the fastening members 3, the stress-relief recessed portions 23 in the interposed plate portion 20 prevent a strong press force from being applied to the surface of the battery cell 1, and thereby avoiding a stress from being locally applied to the upper and lower parts of the battery cell 1. In particular, in the case where the stress-relief recessed portion 23 is formed in the upper end part of the interposed plate portion 20, it is possible to effectively prevent break and deformation of the edge of the upper part of the battery cell 1, in particular, break and deformation of the welding part between the sealing plate 1b and the exterior container 1a. In addition, in the case where the stress-relief recessed portion 23 is formed in the lower end part of the interposed plate portion 20, it is possible to prevent a strong force from being applied to a bottom surface part of the exterior container 1a of the battery cell that is less likely to deform. Therefore, it is possible to protect the exterior container 1a of the battery cell 1, and additionally to surely hold the battery cell 1 between the interposed plate portions 20. On the other hand, the central part of the battery cell 1 is a flat surface part of the exterior container 1a, and is relatively elastic. For this reason, even when a press force is applied to the central part, the force may not immediately damage this central part. As a result, the separators can protect the upper and lower parts of the battery cell 1, and additionally can reliably hold the battery cell 1 between them.

The thus-constructed separators 2 are arranged side by side with being flipped from side to side as shown in FIG. 12 when the separators 2 are sandwiched between battery cells 1. In other words, the separator is orientated in a 180-degree turn from another separator adjacent to this separator. In the case where the separators 2 are arranged in this orientation, the battery cells 1 can be arranged side by side while being flipped from side to side so that the alternately arranged positive/negative output terminals can be connected to each other. Thus, the battery cells can be connected to each other in series. In the illustrated separator 2, since the groove-shaped recessed part 33 is formed in the central part of the bottom surface cover portion 22C, when the separators 2 are arranged side by side while being flipped from side to side, as shown in FIG. 6, the straight groove portion 35 of the groove-shaped recessed parts 33 extends in the central part of the bottom surface of the battery block 10.

### (Battery Assembly)

The battery assembly 9 includes the battery cells 1 and the separators 2, which are alternately arranged side by side, as shown in FIGS. 4 and 8. In the battery assembly 9, the electrically insulating separators 2 are interposed between the battery cells 1 that are adjacent to each other so that the battery cells 1 and the separators 2 are arranged side by side. As a result, the adjacent battery cells 1 are electrically insulated from each other by the separators 2. When the separators 2 are interposed between the battery cells 1, each separator 2 is held by the battery cells 1 that are arranged on both surface sides of this separator 2, while the battery cell 1 is held in place by the separators that are arranged adjacent to this battery cell 1. That is, the battery cell 1 is pressed from both surface sides by the separators 2 that are arranged on the surface sides of this battery cell 1. The battery cell 1 is pressed by the cell press portions 27 and also by the cell contact portions 28 of the separator 2 opposed to the battery cell 1. In the battery block 10 according to the embodiment shown in FIG. 4, the separators 2 that are adjacent to each other are flipped from side to side when being arranged side by side. Accordingly, when the battery cell 1 is sandwiched between two separators 2 that are arranged on both surface sides of this battery cell, the cell press portions 27 of the interposed plate portion 20 of one of the two separators 2 are arranged at opposed positions on the surface sides of the battery cell 1 opposed to the cell press portions 27 of the interposed plate portion 20 of the other of the two separators 2 as shown in FIG. 9. According to this construction, since the opposed positions on both surface sides of the battery cell 1 are pressed by the cell press portions 27, the battery cell 1 can be reliably held.

### (Fastening Member 3)

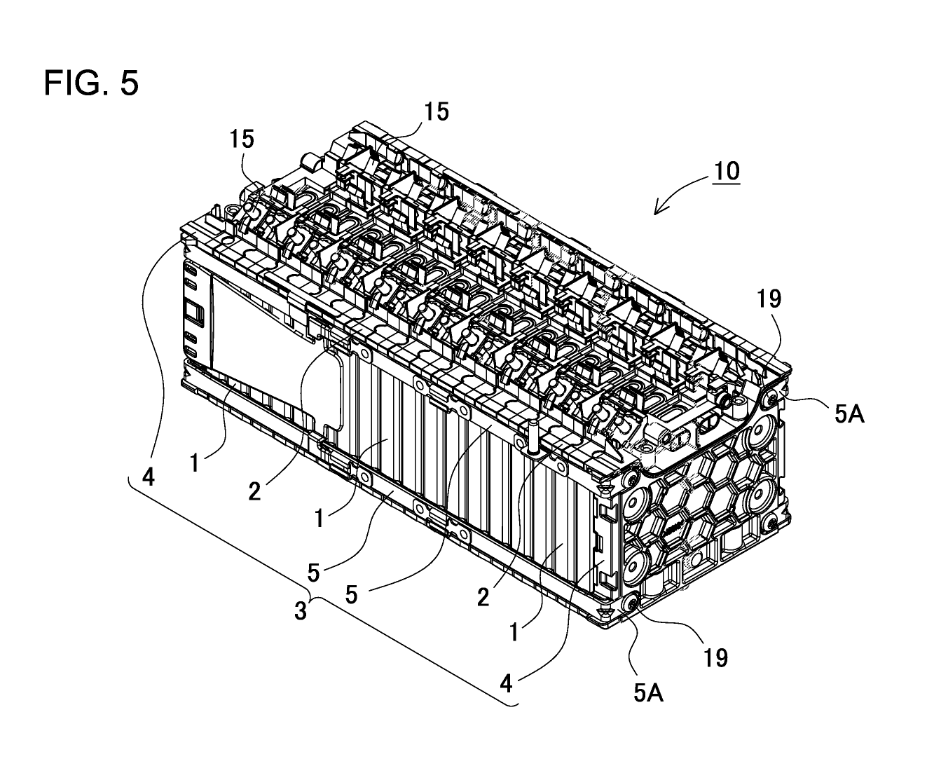

As shown in FIGS. 5 to 8, the battery assembly 9 of the battery cells 1 and the separators 2, which are arranged side by side, is securely held by the fastening members 3. The fastening members 3 include end plates 4, and the bind bars 5. The end plates are arranged on the end surfaces of the battery assembly 9. The ends of the bind bars 5 are coupled to the end plates 4 so that the battery cells 1 are arranged side by side and pressed from the end surface sides of the battery assembly. When the bind bars 5 are coupled to a pair of end plates 4, which are arranged on both end surfaces of the battery assembly 9, the battery cells 1, which are arranged side by side, are pressed in a direction perpendicular to the main surface of the battery cell so that the battery assembly is securely held by the fastening members.

### (End Plate 4)

After the battery cells 1 and the separators 2 of the battery assembly 9 are alternately arranged side by side, as shown in FIGS. 5 to 8, the battery assembly 9 is securely held with the end plates 4 biasing the separators 2 that are located on the end surfaces of the battery assembly 9. The end plate 4 is formed of hard plastic or metal such as aluminum or aluminum alloy. The end plate 4 has substantially the same exterior rectangular shape as the rectangular battery 1 so that the contact area of the end plate 3 with the battery cell 1 can be large. The rectangular end plate 4 has the same size as the rectangular battery 1, or a slightly larger size than the rectangular battery 1. In the case where the end plate is formed of plastic, the end plate 4 is directly fastened to the rectangular battery 1. In the case where the end plate is formed of metal, the end plate 4 is fastened to the battery cell 1 with an electrically insulating member being interposed between the end plate and rectangular battery.

### (Bind Bar 5)

The ends of the bind bars 5 are coupled to the end plates 4. The bind bars 5 are coupled to the end plates 4 by fastening screws 19. Although the bind bars 5 shown in FIGS. 5 to 8 are coupled to the end plates 4 by fastening screws 19, the bind bars may be coupled to the end plates by bending the ends of the bind bars inward or by caulking the ends of the bind bar.

The bind bars 5 can be formed by the working of a metal plate having a predetermined thickness into a metal band having a predetermined width. The ends of the bind bars 5 are coupled to the end plates 4. Thus, the pair of end plates 4 are coupled to each other through the bind bars 5 so that the battery cells 1 are held and pressed. The pair of end plates 4 are fixed at a predetermined interval away from each other by the bind bars 5 so that the battery cells 1, which are arranged side by side between the end plates 4, are held in a predetermined pressure state. If the bind bars 5 expand when the expansion pressure of the battery cell 1 is applied to the bind bars, the bind bars cannot prevent expansion of the battery cell 1. For this reason, the bind bars 5 are formed by the working of a metal plate that has sufficient stiffness to prevent expansion when the expansion pressure of the battery cell 1 is applied, for example, a metal plate of stainless plate such as SUS304 or a steel plate, into a metal band having a width and a thickness that can provide sufficient stiffness. Alternately, the bind bars may be formed by the working of a metal plate into a metal band having a groove shape. Since the thus-shaped bind bars can have a high stiffness against bending, even in the case where the width of the bind bars is small, the battery cells can be arranged side by side and securely held in the predetermined pressure state. The bind bar 5 includes bent parts 5A that are arranged on the ends of the bind bar. The bent parts 5A are coupled to the end plates 4. The bent part 5A has a through hole for receiving the fastening screw 19. The fastening screws 19 are inserted into the through holes, and screwed to the end plates 4 so that the bind bar is fastened to the endplates.

### (End Separator 2′)

In addition, the battery block 10 shown in FIG. 8 includes end separators 2′. The end separator 2′ is interposed between the end plate 4 and the battery cell 1 that is arranged on each of the end surfaces of the battery assembly 9. The end separators 2′ are electrically insulative. According to this construction, the electrically insulating end separator 2′ can electrically insulate the battery cell 1, which includes the metal exterior container 1a, from the metal end plate 4. As a result, it is possible to reliably electrically insulate the battery cells 1, which are arranged side by side, from each other. Therefore, it is possible to provide a more reliable power supply device. Similar to the aforementioned separator 2, the end separator 2′ can have recessed parts that form the gas-flowing paths 6 between the battery cell 1 and the end plate so that cooling gas can flow along surfaces of the battery cell 1, which is opposed to this end separator 2′. That is, the end separator 2′ can have gas-flowing grooves 21 that are formed on a surface that is opposed to the battery cell 1 and extend from one side to the other side of the separator 2 so that the gas-flowing paths 6 can be formed between the main surface 1A of the battery cell 1 and the end separator 2′.

### (Bus Bar)

After the battery cells 1 are arranged side by side so that the battery assembly 9 is constructed, the positive/negative output terminals 15 of the battery cells 1 are connected to each other so that the battery cells 1 are connected in series and/or in parallel to each other. In the battery assembly 9, the positive and negative out terminals 15 of adjacent battery cells 1 are connected in series and/or in parallel to each other by bus bars (not shown). In the case where the rechargeable battery cells of the battery assembly adjacent to each other are connected in series to each other, the output voltage of the battery assembly can be high. In the case where the rechargeable battery cells of the battery assembly adjacent to each other are connected in parallel to each other, the charging/discharging current of the battery assembly can be high.

The fastening screw 15A as the output terminal 15 is inserted into the bus bar. A nut is threadedly engaged with the fastening screw 15A. Thus, the bus bar is fastened to the output terminal 15. The bus bar is a metal plate that has through holes on both end parts of the bus bar. The through holes receive the fastening screws 15A as the output terminals 15 of the battery cells 1 adjacent to each other. The bus bar is arranged on the connection leads 14 with the output terminals 15 passing through the bus bar. The bus bar electrically connects the output terminals 15 of the adjacent battery cells 1 to each other. The connection pattern between the output terminals of the adjacent battery cells 1 depends on serial connection or parallel connection. That is, in the case of serial connection, the positive terminal of one of the adjacent battery cells is connected to the negative terminal of the other of the adjacent battery cells. In the case of parallel connection, the positive and negative terminals of one of the adjacent battery cells are connected to the positive and negative terminals of the other of the adjacent battery cells, respectively. In the case of the power supply device in which the battery cells 1 are serially connected to each other, the output voltage of the battery pack can be high. Note that, in the power supply device according to the present invention, battery cells adjacent to each other may be connected in parallel to each other so that the current capacity of the power supply device can be high.

The aforementioned battery block 10 is fastened to the one surface of the base plate 7 so that the battery block 10 is positioned in place. In the power supply device, shown FIGS. 3 and 4, the lower case section 51B of the exterior case 50 serves as the base plate 7. The battery block 10 is fastened to the lower case section 51B. The battery block 10 is fastened by fastening screws 55 that pass through the lower case section 51B as shown in FIGS. 3 and 4. After passing through the lower case section 51B, the fastening screws 55 are screwed into the end plates 4 on the end surfaces of the battery block 10 so that the battery block 10 is fastened to the upper surface of the lower case section 51B. The end plate 4 has screw holes 4a that are formed in the bottom surface, and can threadedly engage with the fastening screws 55 as shown in FIG. 6.

The battery block 10 is fastened onto the lower case section 51B with the elastic sealing member 8 being interposed between the battery block 10 and the lower case section 51B. When being interposed between the battery block 10 and the lower case section 51B as the base plates 7, the sealing member 8 is deformed by the battery block 10 and the base plate 7 so that the gap between the battery block 10 and the lower case section 51B can be airtightly closed. In the power supply device shown in FIG. 3, the fastening screws 55 are screwed into parts of the end plates 4 in proximity to the sealing member 8, which is arranged on the bottom surface of the battery block 10, so that the battery block 10 is fastened to the lower case section. According to this construction, since the sealing member 8 can be elastically deformed by the fastening force for fastening the end plates 4 to the base plate 7, it is possible to more securely close the gap between the battery block 10 and the base plate 7.

### (Sealing Member 8)

The sealing member 8 is interposed between the bottom surface of the battery block 10 and the upper surface of the base plate 7, and airtightly closes the gap between the bottom surface of the battery block 10 and the upper surface of the base plate 7. The sealing member 8 is an elastic airtight member formed of urethane or EPDM. The sealing member 8 has a band shape that can be obtained by cutting. The sealing member 8 extends along the straight groove portion 35 so that the sealing member 8 can be held in the straight groove portion 35, which are formed on the bottom surface of the battery block 10. The sealing member 8, which is held in the straight groove portion 35, has a width substantially equal to the width (d) of the recessed parts 33 of the separators 2, a thickness greater than the depth of the recessed parts 33, and a length substantially equal to the entire length of the straight groove portion 35. The thus-constructed sealing member 8 is held in the straight groove portion 35, which is formed on the bottom surface of the battery block 10, as shown in FIGS. 3 and 6, so that the sealing member 8 is fastened in a predetermined position between the bottom surface of the battery block 10 and the upper surface of the base plate 7.

When sandwiched between the battery block 10 and the base plate 7, the elastically deformable sealing member 8 is pressed and elastically deformed by the battery block 10 and the base plate 7. Since the elastically deformable sealing member 8 can absorb the clearance between the battery block 10 and the base plate 7, it is possible to reliably close this clearance. Parts of the elastically deformable sealing member 8 that are opposed to the recessed parts 33 of the separators 2 can be deformed to a relatively large extent, while other parts of the sealing member 8 that are opposed to the bottom surface openings 26 opened on the bottom surface of the battery block 10 can be deformed to a relatively small extent, as shown in the enlarged cross-sectional view of FIG. 4, so that the sealing member 8 can partially come into the bottom surface openings 26. The parts of the sealing member 8 that come into the bottom surface openings 26 can press the welded parts 11a, which protrude from the bottom surfaces of the battery cells 1, toward the bottom surfaces of the battery cells 1 whereby closing the bottom surface openings 26 without damaging the welded parts 11a. As a result, it is possible to reduce air leakage through the bottom surface openings. As discussed above, when the sealing member 8 is arranged in the straight groove portion 35, and sandwiched between the battery block 10 and the base plate 7, the parts of the sealing member 8 that are opposed to the groove-shaped recessed parts 33 of the bottom surface cover portions 22C can be elastically deformed so that the gap between the battery block 10 and the base plate 7 can be airtightly closed, while the parts of the sealing member 8 that are opposed the bottom surface openings 26 can come into the bottom surface openings 26 so that the bottom surface openings 26 can be also closed. Therefore, it is possible to effectively prevent that cooling gas flows through the gap between the battery block 10 and the base plate 7.

### (Air Duct)

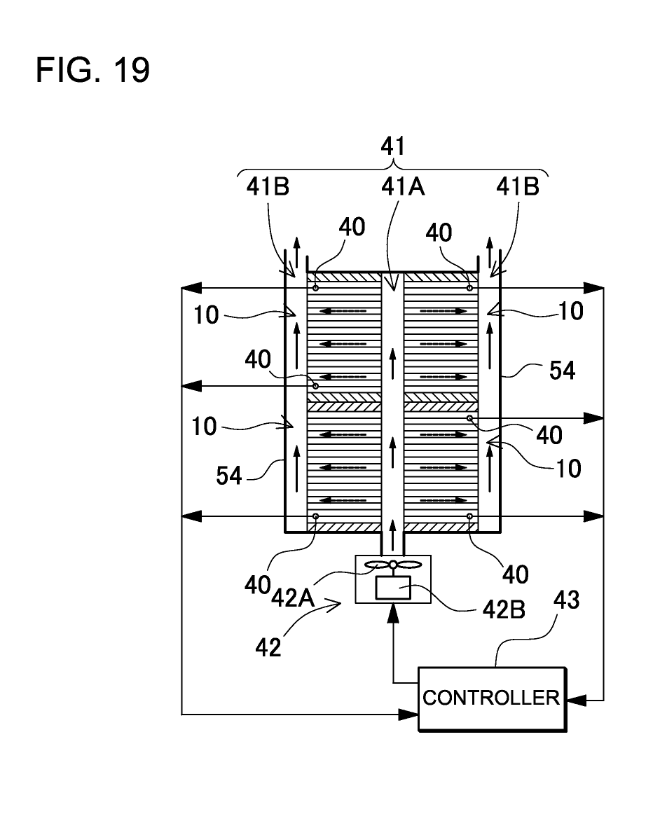

In order to forcedly blow cooling gas through the gas-flowing paths 6, which are formed between the battery cells 1 and the separators 2, as shown in FIGS. 17 and 19, the power supply device includes a set of gas-flowing ducts 41, and a forcedly-gas-blowing mechanism 42. The gas-flowing ducts 41 are formed on the right and left sides of the battery block 10. The forcedly-gas-blowing mechanism 42 is connected to the gas-flowing ducts 41. In this power supply device, cooling gas is forcedly blown, and passes through the gas-flowing paths 6 from one of the gas-flowing ducts 41 so that the battery cells 1 can be cooled. Also, in this power supply device, warm gas may be forcedly blown, and passes through the gas-flowing paths 6 from one of the gas-flowing ducts 41 so that the battery cells 1 may be warmed.

The gas-flowing ducts 41 include inlet and outlet ducts 41A and 41B. The inlet and outlet ducts 41A and 41B are arranged on both sides of the battery block. Cooling gas flows from the inlet duct 41A into the gas-flowing paths 6, and is discharged through the outlet ducts 41B so that the battery cells 1 can be cooled. In the power supply device shown in FIGS. 3 and 19, the inlet duct 41A is formed between the battery blocks 10, which are arranged in the two rows, while the outlet ducts 41B are formed between outside surfaces of the battery blocks 10, which are arranged in the two rows, and side wall portions 54 of the exterior case 51. The gas-flowing paths 6 are connected in parallel to each other between the inlet duct 41A and the outlet duct 41B. Accordingly, after flowing into the inlet duct 41A, cooling gas is branched and flows into the gas-flowing paths 6 so that the cooling gas flows from the inlet duct 41A to the outlet duct 41B. In the power supply device shown in FIGS. 3 and 19, since the inlet duct 41A and the outlet duct 41B are formed on both sides of the battery block 10, the gas-flowing paths 6 extend in the horizontal direction. The cooling gas flows through the gas-flowing paths 6 in the horizontal direction, and can cool the battery cells 1. However, the power supply device may have the gas-flowing paths that extend in the vertical direction, and a pair of gas-flowing ducts that are formed on the opposed, upper and lower surfaces of the power supply device.

### (Forcedly-Gas-Blowing Mechanism 42)

The forcedly-gas-blowing mechanism 42 shown in FIG. 19 includes a fan 42A that is rotated by an electric motor 42B. The fan 42A is connected to the gas-flowing ducts 41. In the power supply device, the forcedly-gas-blowing mechanism 42 is connected to the inlet duct 41A so that cooling gas is forcedly blown into the inlet duct 41A by the forcedly-gas-blowing mechanism 42, for example. In this power supply device, cooling gas flows from the forcedly-gas-blowing mechanism 42 through the inlet duct 41A, and the gas-flowing paths 6, to the outlet ducts 41B so that the battery cells 1 can be cooled. It is noted that the forcedly-gas-blowing mechanism may be connected to the outlet duct. In this case, cooling gas can be forcedly drawn from the outlet duct by the forcedly-gas-blowing mechanism, and is exhausted. Thus, in this power supply device, cooling gas can flow from the inlet ducts, through the gas-flowing paths, and the outlet duct to the forcedly-gas-blowing mechanism so that the battery cells can be cooled. The cooling gas to be blown is air. However, instead of air, the cooling gas may be inert gases such as nitrogen and carbon dioxide. In the case where the power supply device uses inert gas as the cooling gas, the cooling gas circulates through the gas-flowing paths, ducts and the like so that the battery cell can be cooled. The circulating inert gas is cooled by a heat exchanger for cooling the inert gas that is connected to a certain point of the circulation path. The circulating inert gas circulates through the inlet duct, the gas-flowing paths, the outlet duct, and the forcedly-gas-blowing mechanism so that the battery cell can be cooled.

### (Control Circuit 43 and Temperature Sensor 40)

A control circuit 43 controls operation of the electric motor 42B, which rotates the fan 42A. The control circuit 43 controls operation of the electric motor 42B of the forcedly-gas-blowing mechanism 42 in accordance with the signals from temperature sensors 40. In the battery block 10, the temperature sensors 40 are thermally connected to some of the battery cells 1. The temperature of the entire battery block 10 is estimated based on the temperatures of the battery cells 1 that are detected by the temperature sensor 40. The control circuit 43 controls cooling operation or charging/discharging current in accordance with the temperature of the battery block 10. When the highest temperature of the temperatures detected by the temperature sensors 40 becomes higher than a predetermined temperature, the control circuit 43 activates the electric motor 42B of the forcedly-gas-blowing mechanism 42 so that cooling gas is forcedly blown through the gas-flowing paths. When the highest temperature becomes lower than the predetermined temperature, the electric motor 42B is deactivated. The control circuit 43 can control the electric power supplied to the electric motor 42B in accordance with the temperatures detected by the temperature sensors 40 so that the temperatures of the battery cells 1 can be adjusted within a predetermined range. For example, when the temperatures detected by the temperature sensors 40 rise, electric power supplied to the electric motor 42B can be gradually increased so that the gas-flowing amount of the forcedly-gas-blowing mechanism 42 can be increased, while when the detected temperatures decreases, electric power supplied to the electric motor 42B can be reduced. Thus, the temperatures of the battery cells 1 can be adjusted within a predetermined range.

The aforementioned power supply devices can be used as a battery system for vehicles. The power supply device can be installed on electric vehicles such as hybrid cars that are driven by both an engine and a motor, and electric vehicles that are driven only by a motor. The power supply device can be used as a power supply device for these types of vehicles.

### (Hybrid Car Power Supply Device)

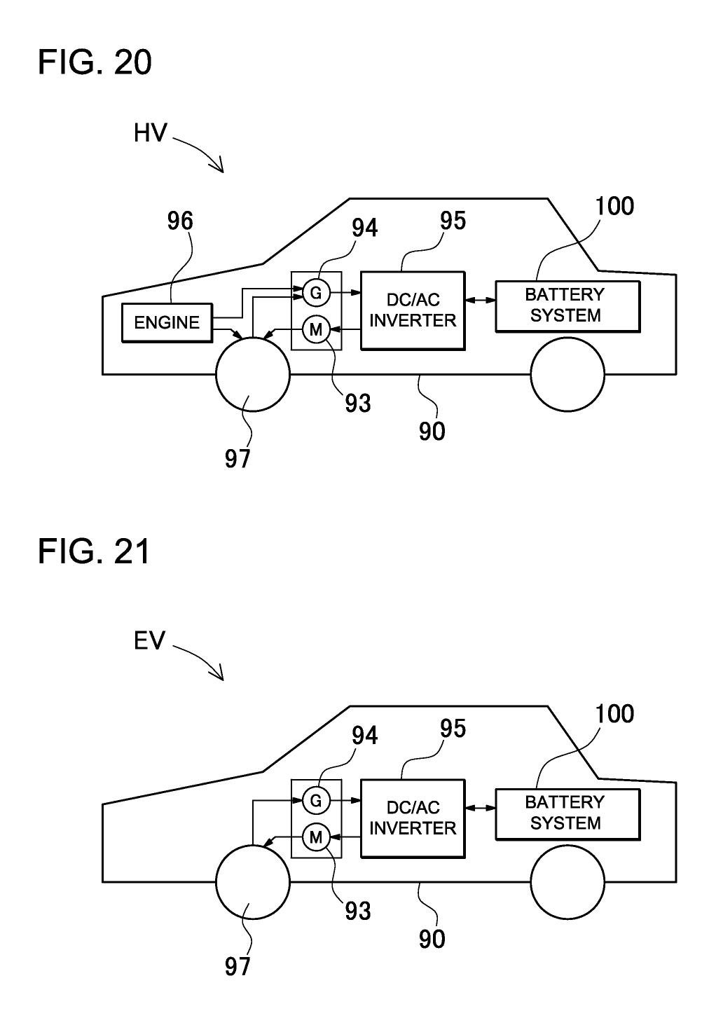

FIG. 20 is a block diagram showing an exemplary hybrid car that is driven both by an engine and an electric motor, and includes the power supply device. The illustrated vehicle HV including the power supply device includes an electric motor 93, an internal-combustion engine 96, the power supply device 100, an electric generator 94, a vehicle body 90, and wheels 97. The electric motor 93 and the internal-combustion engine 96 drive the vehicle HV. The power supply device 100 supplies electric power to the electric motor 93. The electric generator 94 charges battery cells of the power supply device 100. The vehicle body 90 accommodates the internal-combustion engine 96, the electric motor 93, the power supply device 100, and the electric generator 94. The wheels 97 are driven for vehicle body 90 travelling by the internal-combustion engine 96 or the electric motor 93. The power supply device 100 is connected to the electric motor 93 and the electric generator 94 via a DC/AC inverter 95. The vehicle HV is driven both by the electric motor 93 and the internal-combustion engine 96 with the battery cells of the power supply device 100 being charged/discharged. The electric motor 93 is energized with electric power and drives the vehicle in a poor engine efficiency range, e.g., in acceleration or in a low speed range. The electric motor 93 is energized by electric power that is supplied from the power supply device 100. The electric generator 94 is driven by the engine 96 or by regenerative braking when a user brakes the vehicle so that the battery cells of the power supply device 100 are charged.

### (Electric Vehicle Power Supply Device)

FIG. 21 shows an exemplary electric vehicle that is driven only by an electric motor, and includes the power supply device. The illustrated vehicle EV including the power supply device includes the electric motor 93, the power supply device 100, the electric generator 94, the vehicle body 90, and wheels 97. The electric motor 93 drives the vehicle EV. The power supply device 100 supplies electric power to the electric motor 93. The electric generator 94 charges battery cells of the power supply device 100. The vehicle body 90 accommodates the electric motor 93, the power supply device 100, and the electric generator 94. The wheels 97 are driven for vehicle body 90 travelling by the electric motor 93. The power supply device 100 is connected to the electric motor 93 and the electric generator 94 via a DC/AC inverter 95. The electric motor 93 is energized by electric power that is supplied from the power supply device 100. The electric generator 94 can be driven by vehicle EV regenerative braking so that the battery cells 20 of the power supply device 100 are charged.

### (Power Storage Type Power Supply Device)

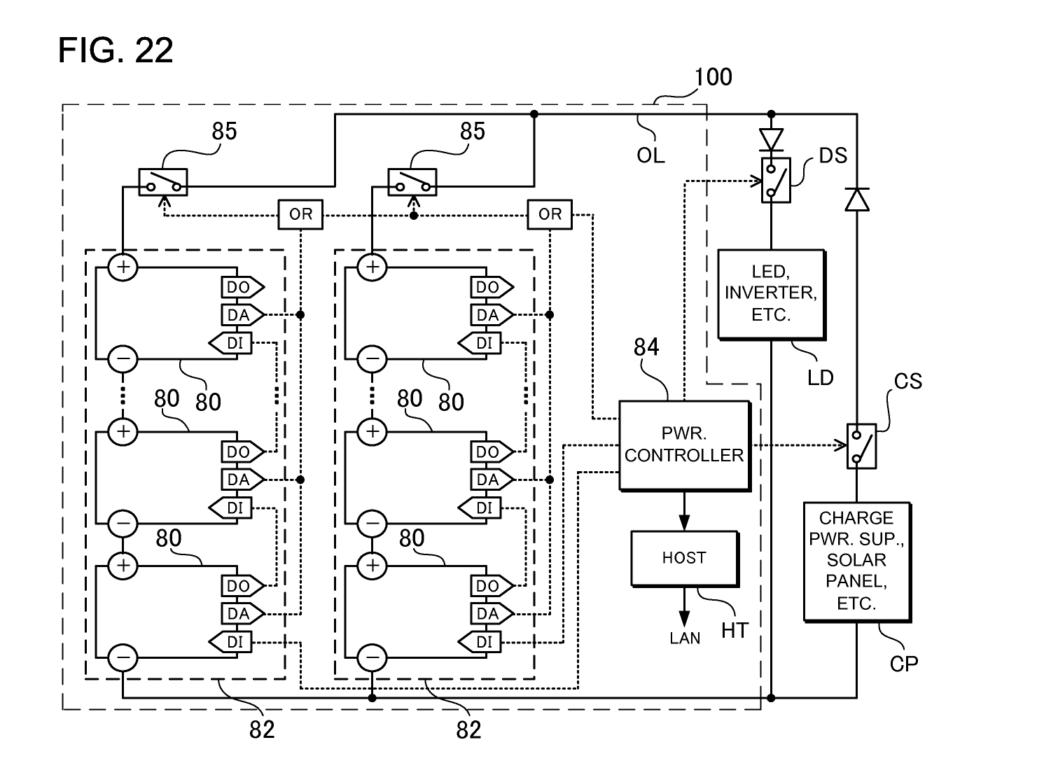

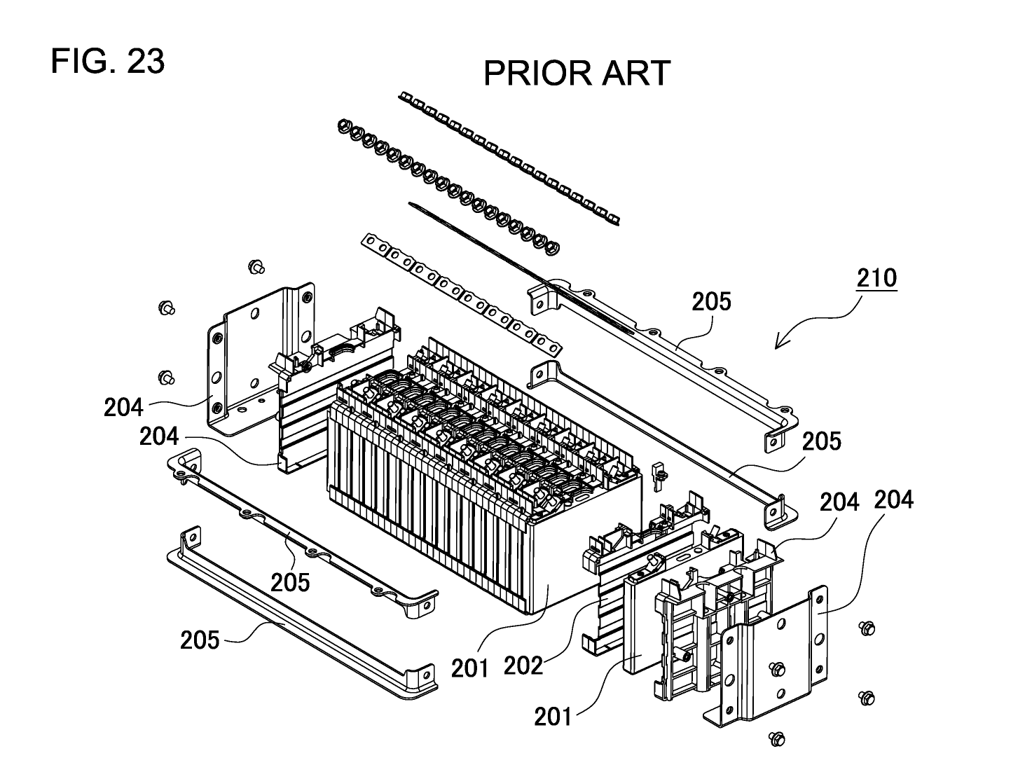

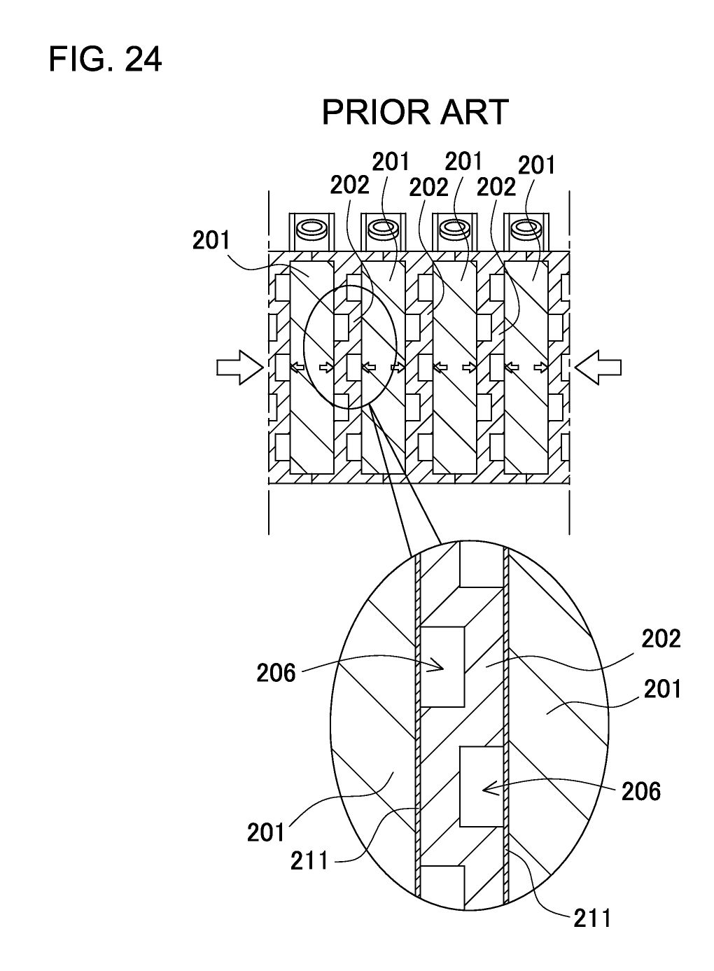

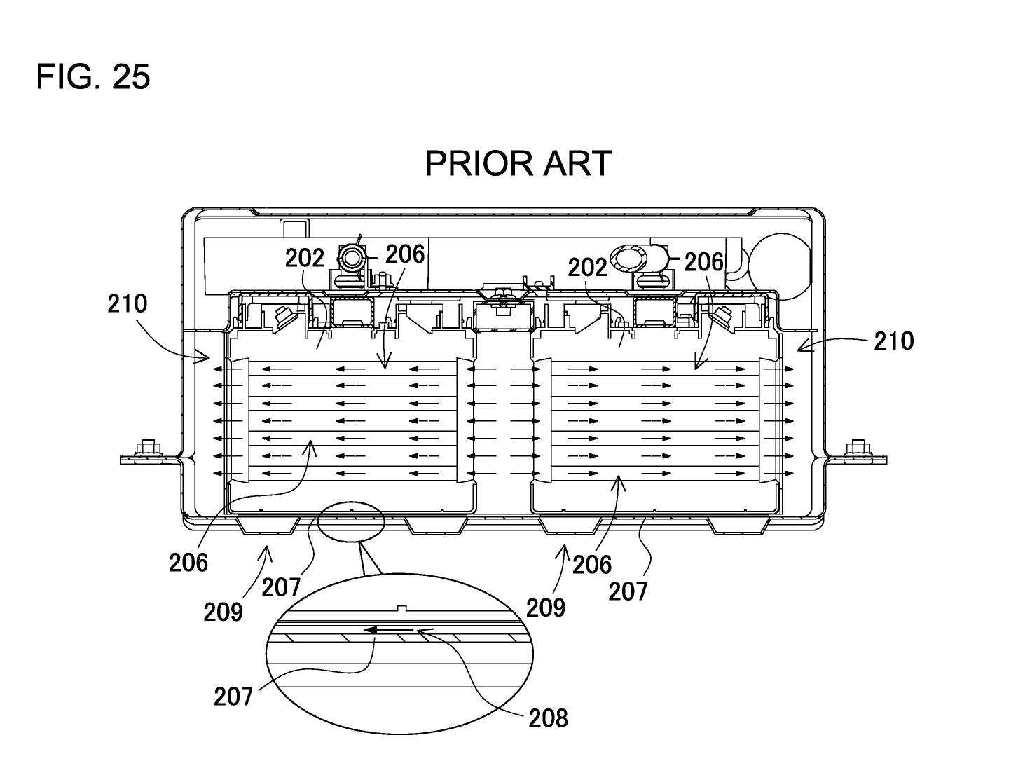

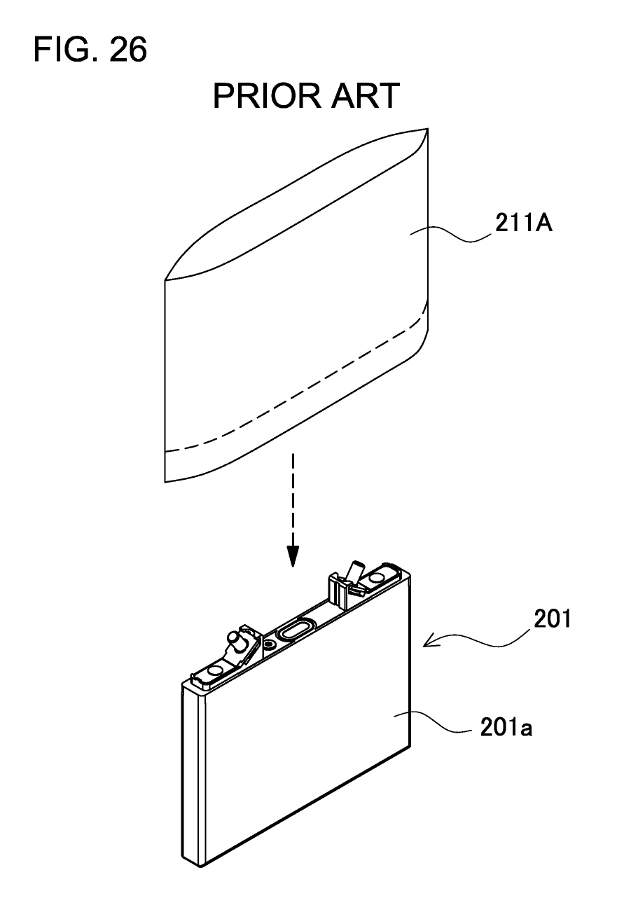

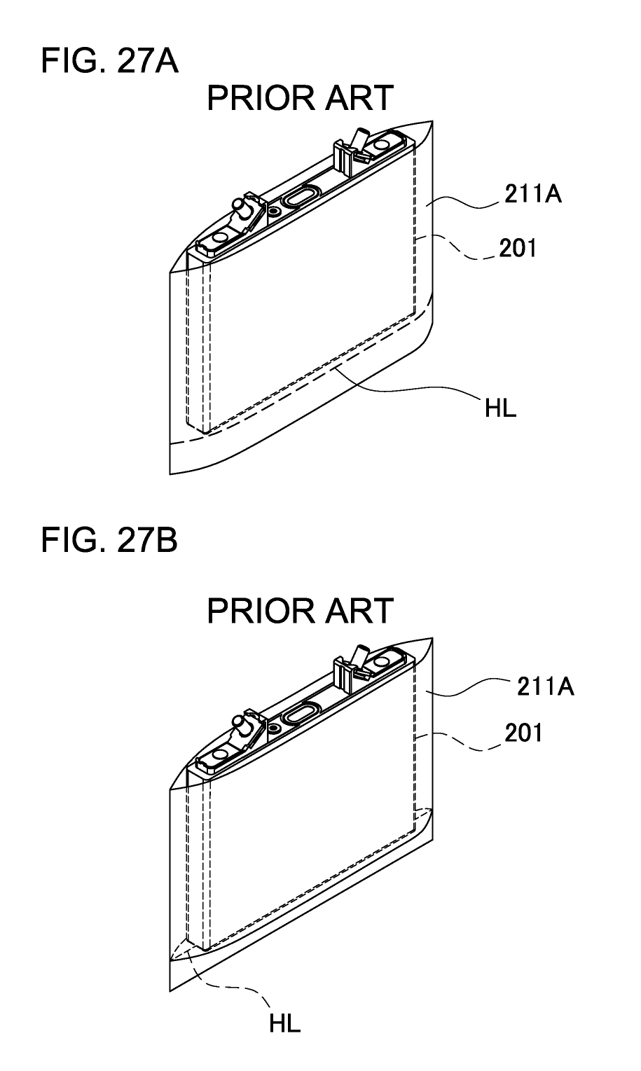

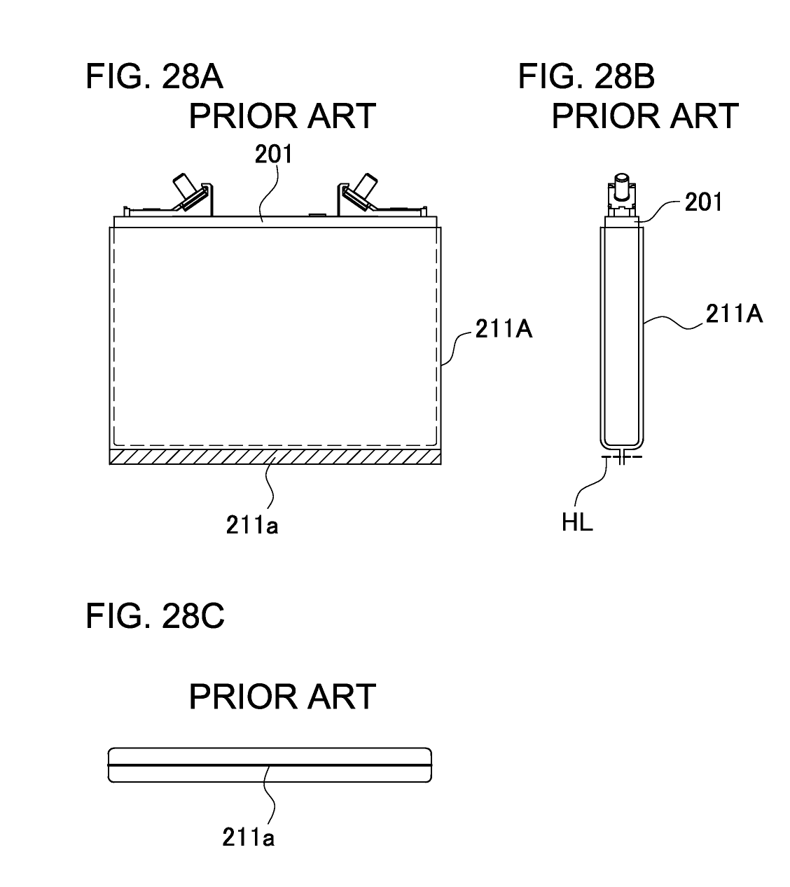

The power supply device can be used not only as a power supply of a mobile unit but also as stationary power storage. For example, examples of stationary power storage devices can be provided by an electric power system for home use or plant use that is charged with sunlight or with midnight electric power and is discharged when necessary, a power supply for street lights that is charged with sunlight during the daytime and is discharged during the nighttime, or a backup power supply for signal lights that drive signal lights in the event of a power failure. FIG. 22 shows an exemplary circuit diagram. This illustrated power supply device 100 includes battery units 82 each of which includes a plurality of battery blocks 80 that are connected to each other. In each of battery blocks 80, a plurality of battery cells 1 are connected to each other in serial and/or in parallel. The battery blocks 80 are controlled by a power supply controller 84. In this power supply device 100, after the battery units 82 are charged by a charging power supply CP, the power supply device 100 drives a load LD. The power supply device 100 has a charging mode and a discharging mode. The Load LD and the charging power supply CP are connected to the power supply device 100 through a discharging switch DS and a charging switch CS, respectively. The discharging switch DS and the charging operation switch CS are turned ON/OFF by the power supply controller 84 of the power supply device 100. In the charging mode, the power supply controller 84 turns the charging operation switch CS ON, and turns the discharging switch DS OFF so that the power supply device 100 can be charged by the charging power supply CP. When the charging operation is completed so that the battery units are fully charged or when the battery units are charged to a capacity not lower than a predetermined value, if the load LD requests electric power, the power supply controller 84 turns the charging operation switch CS OFF, and turns the discharging switch DS ON. Thus, operation is switched from the charging mode to the discharging mode so that the power supply device 100 can be discharged to supply power to the load LD. In addition, if necessary, the charging operation switch CS may be turned ON, while the discharging switch DS may be turned ON so that the load LD can be supplied with electric power while the power supply device 100 can be charged.

The load LD driven by the power supply device 100 is connected to the power supply device 100 through the discharging switch DS. In the discharging mode of the power supply device 100, the power supply controller 84 turns the discharging switch DS ON so that the power supply device 100 is connected to the load LD. Thus, the load LD is driven with electric power from the power supply device 100. Switching elements such as FET can be used as the discharging switch DS. The discharging switch DS is turned ON/OFF by the power supply controller 84 of the power supply device 100. The power supply controller 84 includes a communication interface for communicating with an external device. In the exemplary power supply device shown in FIG. 22, the power supply controller is connected to a host device HT based on existing communications protocols such as UART and RS-232C. Also, the power supply device may include a user interface that allows users to operate the electric power system if necessary.

Each of the battery blocks 80 includes signal terminals and power supply terminals. The signal terminals include an input/output terminal DI, an abnormality output terminal DA, and a connection terminal DO. The block input/output terminal DI serves as a terminal for providing/receiving signals to/from other battery blocks 80 and the power supply controller 84. The block connection terminal DO serves as a terminal for providing/receiving signals to/from other battery blocks 80. The abnormality output terminal DA serves as a terminal for providing an abnormality signal of the battery block 80 to the outside. Also, the power supply terminal is a terminal for connecting one of the battery blocks 80 to another of the battery blocks in series or in parallel. In addition, the battery units 82 are connected to an output line OL through parallel connection switches 85, and are connected in parallel to each other.

A power supply device according to the present invention can be suitably applied to power supple devices of plug-in hybrid vehicles and hybrid electric vehicles that can switch between the EV drive mode and the HEV drive mode, electric vehicles, and the like. Also, a power supply device according to the present invention can be suitably used as backup power supply devices that can be installed on a rack of a computer server, backup power supply devices for wireless communication base stations, electric power storages for home use or plant use, electric power storage devices such as electric power storages for street lights connected to solar cells, backup power supplies for signal lights, and the like.

It should be apparent to those of ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims.

1. A power supply device comprising:
a plurality of battery cells that have a rectangular-box exterior shape and are arranged side by side;
a plurality of separators interposed between said plurality of battery cells; and
a base plate that has one surface onto which a battery block of said plurality of battery cells is fastened; and
an elastic sealing member that is interposed between the bottom surface of said battery block and the upper surface of said base plate to thereby airtightly close gaps between the bottom surface of said battery block and the upper surface of said base plate,
wherein each of said separators has recessed parts that form a plurality of gas-flowing paths between the battery cells so that cooling gas can flow along surfaces of said battery cells when said separators are interposed between said battery cells,
wherein each of said separators includes a plate-shaped bottom surface cover portion that is arranged on a bottom surface side of said separator, and protrudes in the side-by-side arrangement direction of said battery cells,
wherein said bottom surface cover portion has a recessed part that is arranged on said sealing member,
wherein the surfaces of each of said battery cells are covered by an electrically insulating heat contraction sheet,
wherein each of said heat contraction sheet covers and closes one of said battery cells with at least bottom parts of said heat contraction sheet being welded to each other under a bottom surface of said corresponding battery cell,
wherein said bottom surface cover portions of said separators form a bottom surface opening between said separators that are adjacent to each other so that the welded part of said heat contraction sheet can be guided into the bottom surface opening,
wherein, when said separators that are adjacent to each other are opposed to each other, the welded part of said heat contraction sheet can be arranged in the bottom surface opening,
wherein the opening width of the bottom surface opening is wider on both side ends than at a center of the bottom surface opening.

2. The power supply device according to claim 1, wherein said recessed part of said bottom surface cover portion has a groove shape that extends in the side-by-side arrangement direction of said battery cells so that the groove-shaped recessed part opens and extends from one edge to the other edge of said bottom surface cover portion.

3. The power supply device according to claim 2, wherein said groove-shaped recessed parts, which are formed on the bottom surface cover portions of said separators, are aligned in a straight line on the bottom surface of said battery block so that said sealing member is held in a straight groove portion, which is formed by the aligned groove-shaped parts.

4. The power supply device according to claim 3, wherein said groove-shaped recessed part is formed in the central part of said bottom surface cover portion.

5. The power supply device according to claim 3, wherein said sealing member has a band shape that can be held along said aligned groove-shaped parts.

6. The power supply device according to claim 1, wherein said sealing member is formed of urethane or EPDM.

7. (canceled)

8. The power supply device according to claim 1, wherein said bottom surface cover portion has a thickness that is larger than the protruding amount of the welded part.

9. The power supply device according to claim 1, wherein each of said bottom surface openings opens along a center line that divides the bottom surface of said corresponding battery cell into halves in the shorter edge direction.

10. The power supply device according to claim 7, wherein each of said bottom surface openings opens from one side edge to the other side edge of the battery cell.

11. (canceled)

12. The power supply device according to claim 1, wherein the opposed edges of the bottom surface cover portions that are opposed to each other have a curved, trapezoid or triangular convex shape that protrudes in the center of the bottom surface cover portion as viewed from the bottom surface side so that the opening width of said bottom surface opening can be wider on both side ends than at the center of said bottom surface opening.

13. The power supply device according to claim 1, wherein said recessed part has a groove shape that extends in the side-by-side arrangement direction of said battery cells so that the groove-shaped recessed part opens and extends from one edge to the other edge in the central part of said bottom surface cover portion.

14. The power supply device according to claim 1, wherein said base plate has a protruding portion or recessed portion that is formed in at least a part onto which the battery block is fastened.

15. The power supply device according to claim 1, wherein each of said separators includes an interposed plate portion that is sandwiched between said battery cells that are adjacent to each other,
wherein said interposed plate portion includes:
cell contact portions that are alternately arranged on opposite sides of the interposed plate portion as viewed in cross-section so that, when the cell contact portions are interposed between said battery cells that are adjacent to each other, the cell contact portions on one side and the other side alternately come in contact with surfaces of one and the other of the adjacent battery cells; and
cell press portions that couple the side edges of the cell contact portions, which are alternately arranged on the opposite sides of the interposed plate portion as viewed in cross-section, to each other,
wherein the thickness of said cell press portions is thicker than the thickness (t) of said cell contact portions.

16. The power supply device according to claim 1, wherein the device further comprises a forcedly-gas-blowing mechanism that forcedly blows cooling gas to the gas-flowing paths of said battery block to thereby cool the battery cells.

17. A vehicle comprising the power supply device according to claim 1, wherein the vehicle further comprises:
a driving electric motor that is supplied with the electric power from this power supply device;
a vehicle body that accommodates said power supply device and said electric motor; and
wheels that are driven by said electric motor for vehicle traveling.

18. An electric power storage device comprising the power supply device according to claim 1.

19. (canceled)

20. The power supply device according to claim 1, wherein each of said separators includes an interposed plate portion that is sandwiched between said battery cells that are adjacent to each other, wherein said interposed plate portion includes:
cell contact portions alternately arranged on opposite sides of the interposed plate portion as viewed in cross-section so that, when the cell contact portions are interposed between said adjacent battery cells, the cell contact portions on one side and the other side alternately come in contact with surfaces of one and the other of said adjacent battery cells; and
cell press portions coupling side edges of the cell contact portions, which are alternately arranged on the opposite sides of the interposed plate portion as viewed in cross-section, to each other,
wherein the vertical width (D) of said cell contact portions is wider than the vertical width (s) of said cell press portions.
